(19) United States
(12) Patent Application Publication
(10) Pub. No.: US 2007/0266439 A1
(43) Pub. Date: Nov. 15, 2007

(54) PRIVACY MANAGEMENT AND TRANSACTION SYSTEM

(76) Inventor: Harold Kraft, Arlington, VA (US)

Correspondence Address: PROSKAUER ROSE LLP, 1001 PENNSYLVANIA AVE, N.W.,, SUITE 400 SOUTH, WASHINGTON, DC, 20004, US

(21) Appl. No.: 11/562,571

(22) Filed: Nov. 22, 2006

Related U.S. Application Data
(60) Provisional application No. 60/597,432, filed on Nov. 30, 2005.
(60) Provisional application No. 60/597,510, filed on Dec. 6, 2005.
(60) Provisional application No. 60/597,459, filed on Dec. 4, 2005.
(60) Provisional application No. 60/597,664, filed on Dec. 15, 2005.

(51) Int. Cl. H04K 1/00

(52) U.S. Cl. 726/26

(57) ABSTRACT

A system for providing and altering information about users and third parties. The system helps individuals protect themselves against identity theft and identify confusion. Embodiments also provide information about third parties.

### CROSS REFERENCE TO RELATED APPLICATIONS

The present application claims priority to U.S. Provisional Applications Nos. 60/597432, filed Nov. 30, 2005; 60/597510, filed Dec. 6, 2005; 60/597459, Dec. 4, 2005; and 60/597664, filed Dec. 15, 2005.

### BACKGROUND

Background checks are a staple tool used by prospective employers, private and public investigators, detective organizations, prospective spouses, and prospective creditors. Many services are available to generate reports providing information such as criminal background and financial credit-worthiness. More recently, the need for additional information such as verification of institutional credentials has been identified and mechanisms for providing such information proposed. The World Wide Web has spawned a variety of services allowing individuals and organizations to search for specific information about other parties, for example a family could perform a criminal background check on a prospective nanny or find out the owner of a vehicle based on the license plate or vehicle identification number.

In PCT Publication No. WO2005026899 for “CANDIDATE-INITIATED BACKGROUND CHECK AND VERIFICATION,” a system is described in which a candidate for a relationship, such an employment relationship, can initiate a background check of himself, such as would otherwise be performed by the prospective employer. The report obtained is made available to the prospective employer thereby allowing the candidate to eliminate the time and expense burden for the employer or other decision-maker. The ability for the candidate to provide annotations to the records of the candidate's data is provided. Searches may be done on address history, civil records, criminal records, and a social security number verification. A similar system is also described in US Patent Publication No. US2004/088173 for “INTERACTIVE, CERTIFIED BACKGROUND CHECK BUSINESS METHOD.”

In U.S. Pat. No. 6,714,944 for “SYSTEM AND METHOD FOR AUTHENTICATING AND REGISTERING PERSONAL BACKGROUND DATA,” a system is described for creating a database in which information about a candidate is entered into a database and third parties with authority to verify the information can provide such verification information in the database. Then second parties, such as employers, can see not only the background information but the verification information from the third parties as well. So for example, the employer can see the academic degree and a verification token of the institution from which it came. Suitable mechanisms for authentication and authorization are described for generation of the database.

Systems for using background checks automatically to facilitate transactions involving trust have been proposed and implemented. For example, third party systems may facilitate transactions between parties by certifying the credit-worthiness or identities of one or both parties to the transaction. The transactions can be personal as well as commercial.

The public information for background checks also has value in the area of identity theft protection. For years, consumers have been encouraged to check their credit reports for errors and discrepancies. Systems have been proposed to allow a person to perform background checks on himself in order to ascertain what information might be obtained by third parties, such as a prospective employer.

Comprehensive reporting systems of the prior art are generally geared to the needs of businesses, addressing their needs for managing their risk. There is a need in the art for systems that serve the needs not only of commercial end-users but of individual end-users as well

### SUMMARY

A system for providing background check information to consumers may search both primary and secondary sources of data to expose discrepancies and provide consumers the ability to take steps to correct misinformation held in publicly available records. The comprehensiveness of the approach may also help to provide earlier notification of identify theft or fraud. In addition, where the amount of information is large, discrepancies can help highlight information that requires attention.

Consumers need to manage and mitigate different and additional kinds of risk, for example, the risk of corrupt or missing, or information erroneously attached to the consumers' identities. The present system allows consumers to perform a comprehensive check of background information which can provide not only the ability to avoid confusion by third parties, such as prospective employers, but also an indication of fraudulent use of personal information such as would attend an instance of identify theft. Armed with such information, consumers can take steps to protect their identity from further exploitation, mitigate future risk, and repair damage done by identity theft.

A Public Information Profile (PIP), which is a detailed summary of the information available to others about individual, is generated by sifting through many, (e.g., 10 billion records) housed and administered by one or more data aggregators and culled by them from various public sources. In embodiments, a report is generated from these records using a networked architecture and delivered to a user (the subject of the search) via a terminal.

Data sources that may be queried, either directly or through intermediate aggregators, include, for a few examples:

Federal, State and County records

Financial records like bankruptcies, liens and judgments

Property ownership records

Government-issued and other licenses

Law enforcement records on felony and misdemeanor convictions

UCC (Uniform Commercial Code) records that reveal the availability of assets for attachment or seizure, and the financial relationship between an individual and other entities.

The system assembles this information into a single document (the PIP) which may be delivered online as an html or pdf type document or printed and mailed to a user, for example.

Various means of authentication may be provided to prevent someone other than the particular subject of the research from generating that individual's PIP. A preferred mechanism uses identification information about the user and queries one or more data sources for further information. Then the system generates a quiz based on this information to verify the contents of this further information. For example, the quiz may ask the user to indicate which of a list of addresses was a former residence of the user. The question can be generated as a multiple choice question with “none of the above” being a choice, to make it more difficult. Other kinds of questions can be based on the identity of a mortgage company, criminal records, or any of the information the system accesses.

In embodiments, the PIP is generated from a data aggregator, which is a secondary source the collects information from primary sources and makes it available without having to go to the many primary sources. This is done for speed and convenience and aggregators charge a fee for this. The system may generate a PIP which includes a form to accept data from a user indicating that certain data is questionable or indicates misinformation about the person or that some specific piece of data is missing. For example, a criminal conviction comes up on the report or a piece of real estate the user formerly owned fails to show up.

In these embodiments, the user feedback indicating a question about the report contents may be used to generate a further query to primary sources. Many problems can occur in the uptake of data from primary sources to the secondary aggregators used to generate the reports. So a query of the primary sources may indicate the source of the erroneous or missing data as being due to an error in the secondary data source. Since the primary is more authoritative, the correct primary data may be delivered to the user in a second report which juxtaposes the primary and secondary data. The second report may include the user's own comments in juxtaposition, for example, explanations for certain events with citations to supporting data may be entered and included in the report.

In alternative embodiments, rather than querying primary sources in response to a user's indication of questionable data, the primary sources may be queried based on a stored schedule of sensitivity, degree of risk imposed by errors, or likelihood of errors. For example, if the first query of the secondary source turns up criminal records that are closely associated with the user, for example based on an identical name, the primary sources in the associated jurisdiction may be queried to provide verification or highlight a discrepancy in the data.

Another alternative may be to limit the scope of search of primary sources based on “bread crumbs” left by the user throughout his life. For example, the primary sources for each state the user has lived in (as indicated by the query result of the secondary source) may automatically be queried. Yet another alternative is to offer the user a form to ensure that the data obtained and used to query the primary sources is complete. For example, the user may be shown a list of states in which the user appears to have lived based on the first query of the secondary source and asked if the list of states is complete. The user may then enter additional states as needed and the primary sources queried based on the complete list.

Yet another alternative may be to query both secondary and primary sources. This may have value for a user if the secondary source is one that is routinely used by third parties. Discrepancies between the primary and sources can provide the user with information that may help him answer or anticipate problems arising from third party queries of the secondary source. For example, if the user applies for a job and the prospective employer queries the secondary source, the user may be forearmed with an answer to any questions arising about his background. For example, the user may note on his application that there is corrupt data in the secondary source regarding his criminal history. Note that the alternatives identified above may be used alone or in combination.

The results of the primary search may be considered more authoritative since any discrepancies may be the result of transcription errors, data corruption, or some other process that distorts data aggregated from the primary source. A user concerned about misinformation being obtained, and acted upon, by an interested third party, may learn about it in advance and take steps to mitigate its effect. Also, the system may offer a certified report showing both the primary and secondary sources, thereby highlighting and accounting for the discrepancy. In addition, the reports generated by the system, whether by the subject himself or by third parties, can be provided with annotations provided by the user. The annotations may contain explanations for problems that appear in the report, such as explanations of erroneous or misleading information. Preferably, the annotations are juxtaposed with the items in the report. The annotation information may be stored by the service provider.

According to additional embodiments, the second report, with primary as well as secondary data and also with user-entered annotations and citations, may be generated by the user and printed. It may also be generated by third parties using an online process. For example, the system may store the complete second report after querying the primary sources and adding user annotations. The report can be generated by the user or by a third party with the user's permission and under the user's control, for example, by providing the third party with a temporary username and password provided on request to the user by the system and providable by the user to the third party. The credibility of the report may stem from the fact that it cannot be altered directly by the user, the owner of the system deriving much of its value from its integrity as well as the annotations and additional information provided by users.

Also, information supported by primary and secondary data which are discrepant may be submitted by the system operator to operators of the secondary source or sources. This information may be used to alter the secondary source data thereby to remove the discrepancy. Annotations and further citations submitted by the user through the system may also be transmitted by the operator of the system to the operator of the secondary source(s) for purposes of correction.

A user may subscribe to a service offered by the system, for example by paying a one-time fee or a periodic fee, which allows the user to obtain and recompile information. In addition, according to a similar subscription model, the user may receive periodic, or event-driven change reports which indicate changes in the content of the user's PIP. The change report may be delivered as a full report with changes highlighted or as just a report indicating changes that have occurred. During the period of the subscription, the system may compile and keep a record of changes so that an historical record may be created and accessed and reviewed by the user. For example, the user may obtain change reports between any two dates.

Preferably PIP or associated information are provided to highlight data that are particularly sensitive or important and also to indicate the relevance of, or what to do about, problems with each item of the data in the PIP. The PIP may include, along with a detailed listing of findings, a narrative, automatically generated, which discusses the most salient features of the PIP. Such a narrative may be generated using template grammatical structures in a manner used by chatbots (chatterbots) for example, see U.S. Pat. No. 6,611,206, hereby incorporated by reference as if fully set forth in its entirety, herein.

Also, preferably, PIPs will indicate what search criteria were used to retrieve the records it displays. In querying databases, the system ordinarily uses multiple criteria that are alternatives for identifying records. For example, records that cannot be found by social security number or records that have a high probability of matching the target entity (the subject of the search) based on criteria other than social security number, such as name and address, may be returned and included in the report. Thus, an entity's name, social security number, or other information may be used alone or in combination with other data. The matching of criteria may also be inexact. Thus, reports may include matches to misspelled names, addresses which are misspelled, abbreviated, or truncated, and similar variations. Phonetic alternatives to a properly spelled criterion may also be used. Also, similar numbers such as address number or social security number may be used as a search criterion and included in a report. Since the criteria used to match the records may vary, a user reviewing his report may be interested to know how the record was associated with the target (which may the user or a third party) and this may be indicated by the PIP. The criteria themselves may be displayed, for example by identifying the type of field that matched, for example, “address and name,” the matching criteria may be displayed with highlighting, for example the address may be shown in highlighted characters, or other devices may be used, such as by a hyperlink button or mouse-over balloon text, for example.

According to an embodiment, a method of providing a report of public information includes, from at least a network server, transmitting a form with fields for obtaining identifying information, identifying an individual, to a client terminal, receiving at at least a network server from said client terminal, identifying information associated with said form fields, said identifying information substantially uniquely identifying an individual person, at at least a network server, creating a customer profile corresponding to a customer and corresponding to said identifying information, at at least a network server, querying at least two databases containing publicly-available information corresponding to said identifying information, retrieving as a result of said querying, at least two pieces of information relating to a same event, person, or thing, generating a report containing both of said at least two pieces, transmitting said report to a client terminal, said report being arranged to indicate discrepancies at least by displaying both of said two pieces of information.

According to another embodiment, a method of providing a report of public information includes, from at least a network server, transmitting a form with fields for obtaining identifying information, identifying an individual, to a client terminal, receiving at at least a network server from said client terminal, identifying information associated with said form fields, said identifying information substantially uniquely identifying an individual person, at at least a network server, querying, based at least in part on said information an aggregator database containing records from multiple primary data sources including at least state and federal records pertaining to various persons, events, and/or things and retrieving a resulting set of records, at at least a network server, querying one of said multiple primary data sources and retrieving at least one record that pertains to a same one of said various persons, events, and/or things, generating a report containing both of said at least one record and said resulting set of records such that said at least one record can be compared to one pertaining to said same one of said various persons, events, and/or things, by a user, to determine if discrepancies exist, transmitting said report to a client terminal.

According to yet another embodiment, a method of providing a report of public information, includes: generating a user interface to allow customers to obtain personal information about themselves that are stored at publicly-available databases, said user interface permitting customers of a service to enter identifying information and authenticating information, at at least a network server, authenticating a user and storing corresponding identifying information pertaining to said user, at at least a network server, querying, based on said identifying information, an aggregator database containing records derived from a primary database and retrieving aggregator records resulting from said first step of querying, at at least a network server, querying, based on said identifying information, said primary database and retrieving primary records resulting from said second step of querying, generating a report containing said primary and aggregator records in a format that allows comparison by a user, at least one of said primary and aggregator records pertaining to a same person, event, and/or thing and containing redundant information unless a discrepancy between at least a corresponding portion of each of said primary and aggregator records exists.

Various objects, features, aspects and advantages of the present invention will become more apparent from the following detailed description of preferred embodiments of the invention, along with the accompanying drawing.

### BRIEF DESCRIPTION OF DRAWINGS

FIG. 1 illustrates a network or Internet architecture for implementing various features of the present embodiments.

FIG. 2A illustrates an embodiment in which a public information profile report may be generated from a secondary source, such as a data aggregator.

FIG. 2B illustrates an example of a public information profile report which may be generated according to embodiments described in FIG. 2A and elsewhere in the specification.

FIG. 3 illustrates a quiz technique for authenticating a user.

FIG. 4 illustrates an embodiment in which a change report is generated from a user profile and a public information database.

FIG. 5 illustrates a system and method for generating an augmented public information profile report in which questionable information is fixed and/or annotated.

FIG. 6 shows a complete PIP illustrating an embodiment of a report form.

FIG. 7 shows a complete PIP illustrating an embodiment of a fix report.

FIG. 8 shows a portion of a PIP embodiment relating to real estate residences purchased.

FIG. 9 illustrates a portion of an embodiment of a list of data sources accessed.

FIG. 10 illustrates other information that may be included in a PIP.

FIG. 11 shows an example process for searching a database in which the search query is made broader by an iterative process that derives alternative search criteria.

FIG. 12 shows a process related to that of FIG. 11 for iteratively broadening search criteria until a target threshold number of records is reached.

FIG. 13 shows an embodiment of a portion of a public information profile (PIP) which summarizes the contents obtained.

FIG. 14 shows an embodiment of a portion of a public information profile (PIP) which provides links to different portions of the PIP.

FIG. 15 shows an embodiment of a portion of a public information profile (PIP) which provides information and link controls for assistance regarding certain elements of the PIP.

FIG. 16 shows an embodiment of another portion of the public information profile (PIP) which provides information and link controls for assistance regarding certain elements of the PIP.

FIGS. 17A and 17B show collapsed and expanded views of criteria used to show records obtained (a similar embodiment may be included as well to show information about the sources of the information).

FIGS. 18 and 19 illustrate a PIP format feature that helps users understand when discrepancies may arise between one or more data sources and how to cure them.

FIG. 20 illustrates a method for generating and outputting guidance to individuals as to how they are adding to their own risk of identity theft and what they might do to reduce their risk.

FIGS. 21A, 21B, 21C, and 21D illustrate a survey method and output.

FIGS. 22A and 22B illustrate a dashboard style interface for managing identity information.

FIG. 22C illustrates a process associated with the user interface features of FIGS. 22A and 22B.

FIGS. 23A, 23B, and 23C illustrate a process for generating an offender report, such as a sex offender report for a subscriber.

FIG. 24 illustrates a method of identifying potential contact points between an offender and a subscriber, or person of concern.

FIG. 25 illustrates a map graphic that may be included in an offender report.

### DETAILED DESCRIPTION OF DRAWINGS

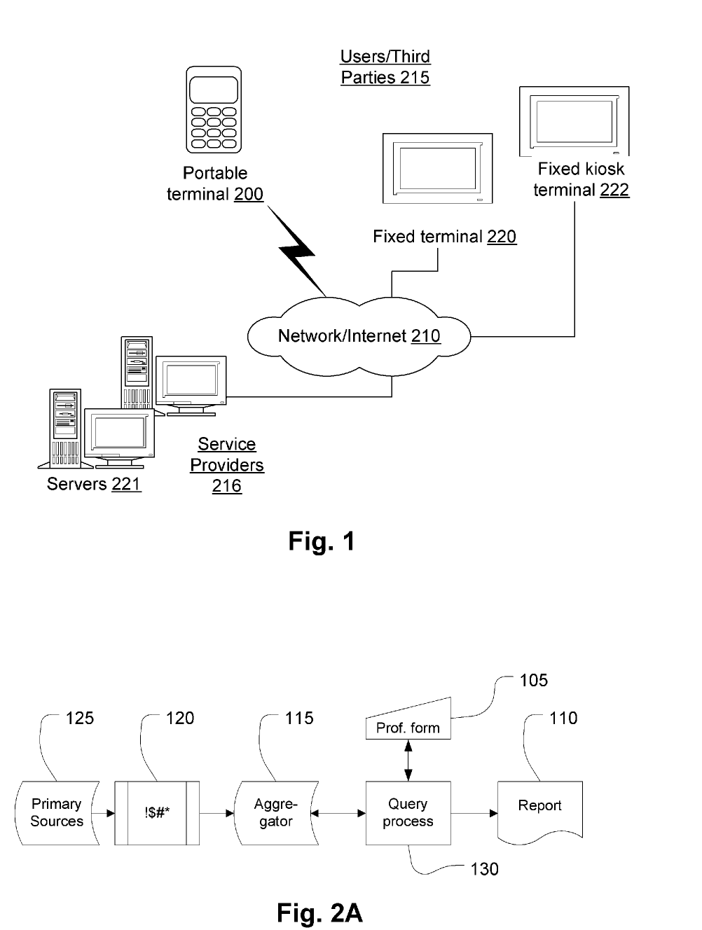

FIG. 1 illustrates a network or Internetwork architecture for implementing the features of the various embodiments. The embodiments concern reports of information from content databases, for example public records of interest to the subjects of the reports, for example, individual consumers. Examples of public records include credit profile data, criminal convictions, financial records such as bankruptcy, and property ownership records. A user 215 may request information from one or more service providers 216 through a wireless 200, or fixed 220, 222 terminal. The request may be entered in a form, for example an html form generated by a server 221, and transmitted to the terminal 200, 220, 222 via a network, internetwork, and/or the Internet 210. Data submitted by the user (or by an interested third party, since the subject of a search may be the user or another person or entity) 215 may be transmitted from the terminal 200, 220, 222 via a network, internetwork, and/or the Internet 210 to the server 221 (which may be the same or a different server or servers) and used to generate a query. The query may be generated on one server 221 and transmitted, via network, internetwork, and/or the Internet 210, to another server 221 and in response data obtained as a result of the query and also transmitted, via a network, internetwork, and/or the Internet 210, to the user or third party 215 at a corresponding terminal 200, 220, 222 or some other location, for example a permanent or semi-permanent data store for future access (not shown separately but structurally the same as servers 221). The network, internetwork, and/or the Internet 210 may include further servers, routers, switches and other hardware according to known principles, engineering requirements, and designer choices.

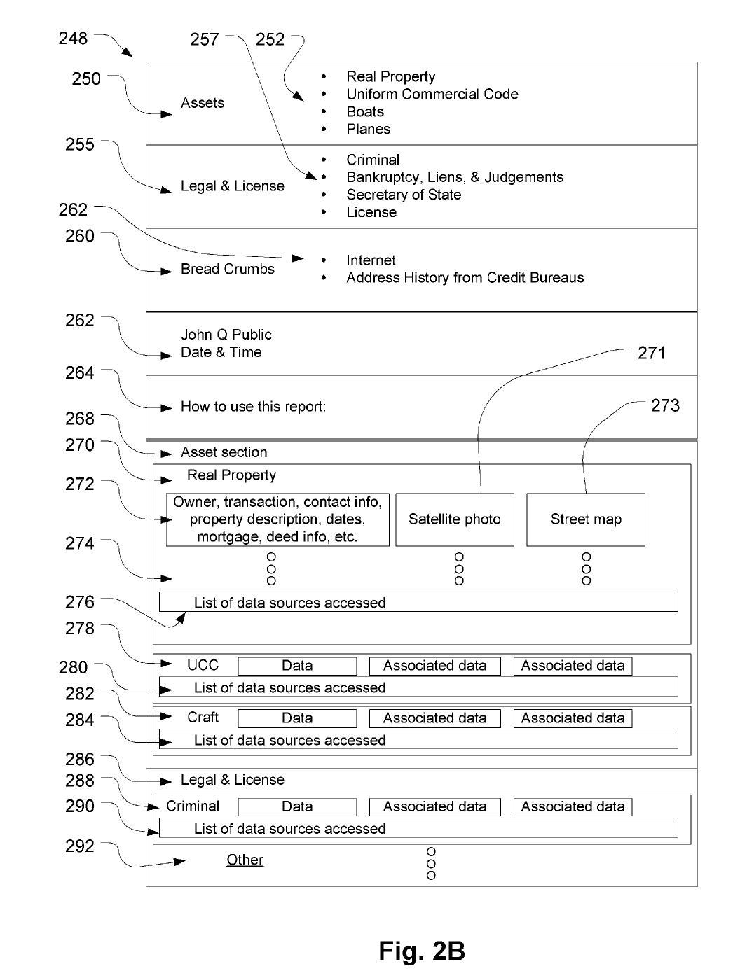

FIG. 2A shows an embodiment in which a public information profile report can be generated from a secondary source, such as a data aggregator. The arrows illustrate data exchange processes which are described in the text. The entities represent computers, servers, and data transfers may occur through networks or internetworks, such as the Internet using any appropriate known protocols. Multiple primary sources 125 of information are queried by the owner of one or more secondary sources 115 to aggregate the contents of the primary sources and make the data available to customers of the owners of the secondary sources (not shown). For example, the secondary sources 115 may include identification and credential verification service or credit bureaus. Secondary sources 115 may provide rapid and complex searches by subscribers. For example, entities such as government offices, the FBI, prospective employers, etc. may subscribe to services of the secondary source 115 providers to do background checks on individuals of concern to the entities. Such individuals may include job applicants, proposed business contacts, constituents, criminal suspects, opposing political candidates, etc. These entities may also obtain information directly from primary sources 115, described below.

When a secondary source 115 obtains data from primary sources 125, the data may suffer any of a variety of changes, such as data corruption, transcription errors, deliberate data manipulation, etc. These may occur in a process of data transfer from the primary source 125 or within the secondary source 115. These changes are represented figuratively by the operator 120. A Public Information Profile (PIP) service which has subscribers who are individuals concerned about their own personal information and misinformation which may be available through the secondary 115 or primary 125 sources. They may obtain data directly from the primary 125 and/or secondary 115 sources and compile a report 110. The report contains all information generated from the primary 125 and/or secondary 115 sources resulting from a query generated by a query process 130 which uses information from a profile form 105 providing data about a user.

Examples of primary and secondary sources 115 and 125 include repositories for:

Property ownership records, real estate records,

Government-issued and other organization and professional licenses and registrations and professional and educational certifications, degrees, etc. These might be found government, employer's or other entity's background information store.

Law enforcement records on felony and misdemeanor convictions. Criminal records and special offender (e.g. sex-offender) registered lists. These include criminal convictions—including misdemeanors and felonies. These records might be found in a government, employer's or other entity's background check.

Financial records like bankruptcy, liens, judgments: These include bankruptcies, liens, and judgments awarded against an individual or individuals. These records might be found in a government, employer's or other entity's background check.

PACER: Public Access to Court Electronic Records (PACER) is an electronic service that gives case information from Federal Appellate, Federal District and Federal Bankruptcy courts.

UCC (Uniform Commercial Code) records that reveal the availability of assets for attachment or seizure, and the financial relationship between an individual and other entities. These include public notices filed by a person's creditors to determine the assets available for liens or seizure.

Secretary of State: including corporate filings identified by the names of agents/officers. An example of a web site offering such information is NY's department of state web site located at: http://www.dos.state.ny.us/

Internet search: matches from databases that may match or cite your name or names similar to yours, from Web search engines, usenet newsgroups, or any other Internet-accessible resource.

Personal Details: matches from databases that are associated with your name or names similar to yours, your past or present address and telephone, your SSN, your relatives, or even people that you have been associated with.

Insurance claims databases, such as CLUE, which store information about insurance claims made by individuals and organizations.

Credit Header Data: the addresses associated with your Social Security Number and name in credit reports. The address history in your PIP can be 10-20 years old. These records might be found in a government, employer's or other entity's background check.

HUD: Department of Housing and Urban Development (HUD) or Federal Housing Administration (FHA) insured mortgage, subject may be eligible for a refund of part of your insurance premium or a share of any excess earnings from the FHA's Mutual Mortgage Insurance Fund. HUD searches for unpaid refunds by name.

PBGC: Pension Benefit Guaranty Corporation, collects insurance premiums from employers that sponsor insured pension plans, earns money from investments and receives funds from pension plans it takes over.

Financial and credit data as provided by the three major credit bureaus.

Census data

Voting records

Telephone disconnects and other telephone company data

United States Postal Service Coding Accuracy Support System (CASS) is an address correction system which compares an address to the last address on file at the USPS for the recipient.

Email databases.

Other Fraud Databases, such as maintained by data aggregators, that associate identifiers, such as a particular physical address, with known risk of fraud.

Telemarketing and Direct Mail Marketing databases.

Retailer databases including customer loyalty databases demographic databases, personal and group purchasing information, etc.

Warranty registration databases.

In the embodiment of FIG. 2A, data is preferably derived from the secondary source or sources 115 to allow the report 110 (e.g., a PIP) to be generated quickly and consistently. This is because the primary sources 125 can be numerous and diffuse; that is, they may be scattered at many different locations and in various states of accessibility. If one were to rely on the primary sources 125, the report 105 would take longer and it would be inconsistent in terms of scope because the unavailability of certain databases. However preferable, the embodiments are not limited to querying only a secondary (aggregator) source. In addition, the secondary source or sources 115 may or may not include content aggregators. They may include content enhancers, i.e., ones which take data from a single source, but which enhance it in some way. For example, the secondary source may store first or third party annotations (described below) or other data and/or the secondary source may buffer data for longer periods of time to enhance the data's availability.

Where various sources contain identical primary information, the elements of this information may be juxtaposed in the PIP for comparison. For example, the PIP may highlight those information elements that contain identical information. The sameness of the data may be determined based on the information itself or from descriptive information from the data source. For example, an address record may contain the same address with different valuations of the price paid for the property on a particular date. The discrepancy may be highlighted in the report by aligning the identical records, such as in adjacent rows of a table with the corresponding elements aligned in columns. In this way discrepancies in the data may be discerned easily by the user.

In terms of methods, a user may authenticate himself by logging into the query process 130. The query process may generate a form 105 that accepts data from the user identifying him. This data may be used by the query process 130 to generate a query that is used to retrieve contents from the secondary source 115. The identifying data accepted by the form may include authentication information that includes private information that the user would normally keep secret, such as his social security number. The query process 130 may use discrepancies in the data as a basis for rejecting the request for a PIP by generating an appropriate user interface element such as a dialog box. The secondary source 115 generates a set of data from the query by filtering and sorting its internal database and transmits them to the query process 130 which then formats and adds additional data (described below) to generate the report 110. An element of the method is content aggregation performed by the secondary source 115 in which data is regularly obtained by an internal query process (not shown) is applied to the primary sources 125 to obtain comprehensive compilations of data which are stored by the secondary source 115.

FIG. 2B illustrates an example of a public information profile (PIP) report which may be generated according to embodiments described in FIG. 2A and elsewhere in the specification. A navigation header 248 includes categorical areas 250, 255, and 262 which may be hyperlinked, with subcategory links 252, 257, and 262. Categorical areas 250, 255, and 262 represent assets, legal and license records, and bread crumbs, respectively. The meanings of the categories should be apparent from the text subcategory links 252, 257, and 262 shown in the drawing and from the details illustrated further on. The bread crumbs area is for information that can be compiled from various sources that represent random information relating to the user, for example, it may be such as an Internet search on the user's name or other identifier would provide.

Area 262 is a summary header providing identifier information about the user who is the subject of the report, a summary of the results, and date and time information or other information that qualifies the report. The summary of the results may include subject matter categories 294 . . . 296 with corresponding results 295 . . . 299 and corresponding explanations 297 . . . 298. The categories 294 . . . 296 may follow the categories 250, 255, 260 and/or subcategories 252, 257, 262 described below. The results 295 . . . 299 may simply indicate the number of positive hits (records associated with the user) found within each category. Respective explanations 297 . . . 298 may indicate what search criteria produced any positive hits or may summarize all of the criteria which were tried. For example, it may recite as follows:
5 properties found based on SSN, in MD, NY, & VA. 1 additional found based on “John Public” in VT. Tried SSN, “John Quincy Public;” “John Q Public;” and “John Public” in all sources listed in summary section.
0 properties found based on SSN, “John Quincy Public;” “John Q Public;” and “John Public” in all sources listed in summary section.
   where “SSN” stands for social security number.

The summary header 262 may also include information about limits placed on the content of the report, who is authorized to read it, etc. Area 264 indicates a blurb or a link to the same to describe in summary fashion how to use the report, what its limits are, and what to do about misinformation appearing in the report.

Area 268 is the asset category section and it includes the section 270, which is the first section delivering results from a search. This section 270 is a real property report and includes subsection 272 which describes information about the first property, such as transaction data, property description, mortgage companies, parties involved in the transaction, etc. The section 272 may accompanied by graphics such as a satellite photo 271 and street map 273 of the property and surrounding area. Also illustrated is a citation/criteria block 277 indicating the particular source of each item of information and what criteria produced the positive result. The citation/criteria block 277 may be provided on a record by record or field by field basis. It may indicate a category of the secondary source 115 or a particular primary source 125 or category (part of the source database) from which the associated data item originated. Other items such as assessed value, values for comparables in the neighborhood, etc. may also be provided. The ellipses at 274 indicate that many records may follow as appropriate. After the record data, at 276, the list of sources searched may be indicated. The list of sources 276 may identify primary sources 125 or secondary sources 115 or portions thereof, whether the data was derived through the primary or secondary source. For example, the secondary source 115 may identify the primary source from which a datum was originally obtained by the secondary source 115. This original source information may be passed through the secondary source 115 and the data attributed to the primary source even though, for purposes of generating the report, it was derived from the secondary source 115.

One of the important pieces of information included in a PIP is what it does not show, that is, the lack any hits after a particular database is searched. A consumer may be just as interested in a failure of the PIP to show a record as in a record showing up which is either wrong or should not be identified with the user. Thus, the list of data sources accessed is a useful component of the report and may therefore be included in the body of the PIP.

Further sections and records such as the UCC report area 278, Craft report area 282 to show records such as for planes and boats registered to the user, legal and license area 286 with criminal records 288 may include corresponding lists of data sources 280, 284, and 290. Further records grouped by category and listed as indicated in the navigation header 248 may be shown as suggested by the ellipses 282.

The entire report of FIG. 2B may be delivered as a digital document, a printed document, or an html page or any other means. It may be encoded on a smart card or other portable data store. Authentication information may be included in the report, for example, a hologram seal on a printed report, to provide some verification capability that the report is true to the information and reporting done by the service associated with system FIG. 2A.

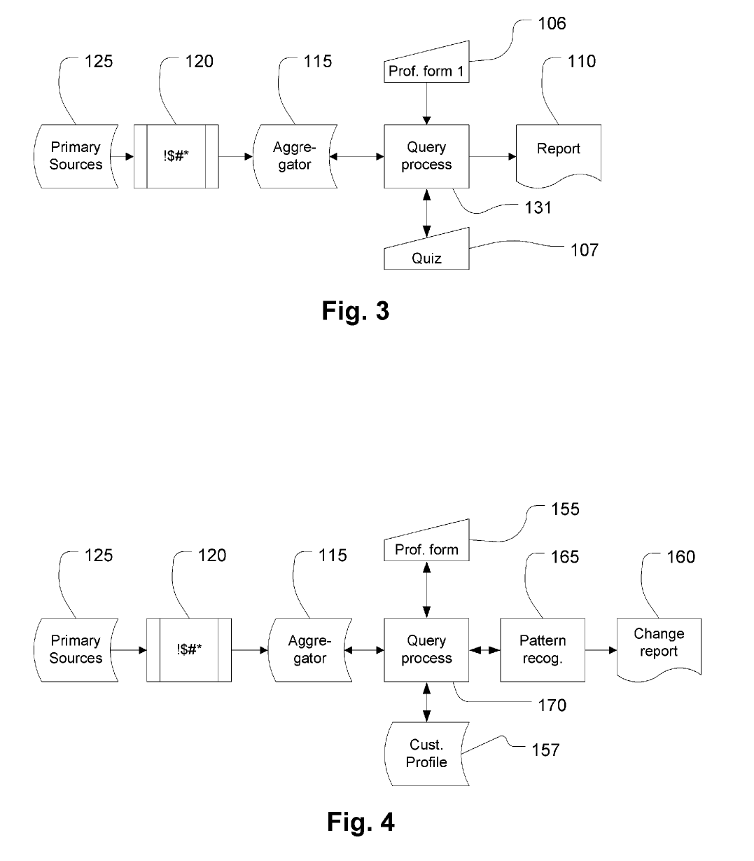

FIG. 3 shows an embodiment in which feedback is obtained to further confirm the identity of a user. Here, as in further embodiments, like numerals indicate similar or identical components and are not redundantly described for that reason. In this embodiment, after identification/authentication information is obtained through the form 106, the query process 131 calls up information from the secondary source 115 and creates a quiz. The quiz tests the identity of the user by asking questions about information the user would likely know but someone other than the person would not. This guards against someone benefiting from finding or stealing the user's wallet or other personal effects containing personal information. For example, the quiz may ask the user to indicate which of a list of addresses was a former residence of the user. The question can be generated as a multiple choice question with “none of the above” being a choice, to make it more difficult. Other kinds of questions can be based on the identity of a mortgage company, criminal records, or any of the information the system accesses. The query process 131 may employ predefined rules for the purpose of generating the quiz. For example, the process 131 may rely on a randomized selection of data such as mortgage company, old addresses, previous employers, locations where craft were registered and what kind, size of houses previously owned, etc. The query process 131 may further rely on the effectiveness of candidate discriminators to distinguish among possible users, for example, by doing a search on individuals similar to the person identified by the identification/authentication information and then basing questions on what makes each unique compared to the others. This is a more flexible approach and can be implemented using a simple frequency filter that identifies the questions whose answers are least likely to be shared by two or more in the search result of similar individuals.

FIG. 4 illustrates an embodiment in which a change report is generated from a user profile and a public information database. The process and system represented by FIG. 4 is similar to that of FIG. 2A, except that after the query process 170 authenticates the user and generates and transmits a PIP, at least some parts of the PIP are stored in a profile 157 associated with the particular user. Then, periodically, the query process 170 queries the secondary source 115 and compares the resulting filtered set of data to the data stored in the profile 157. In an embodiment, any changes in the secondary or primary sources indicated by a comparison between baseline data stored in the profile 157 and the most recent query of the secondary and/or primary sources 115,125 are identified and shown in a change report.

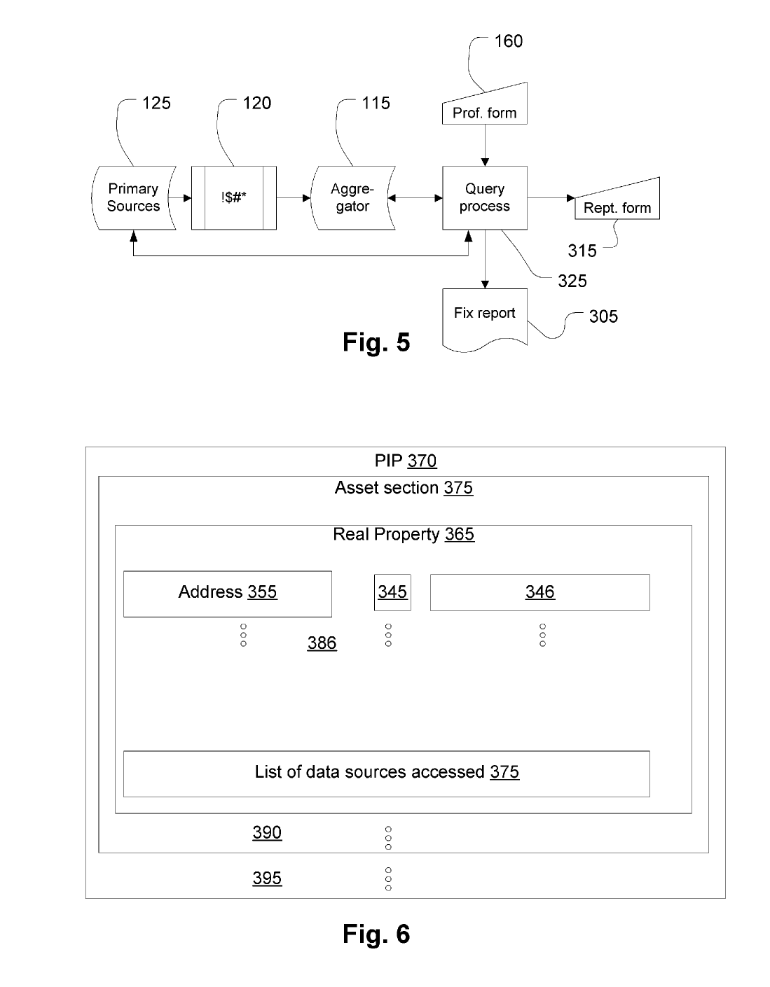

In another emobodiment, a query process 170 may follow a pattern recognition process 165 to identify certain kinds of changes. For example, the pattern recognition process 165 may be trained to identify traces of fraudulent actions. These patterns may be diffuse, such as certain kinds of monetary withdrawals that look like someone trying to hide under the radar or focused such as the registration of a vehicle in a state in which the user has no previous ties. When the pattern recognition process 165 identifies one or more events of interest, it may generate a notification to the user, such as by SMS messaging or email and provide access to a report providing details of the event(s) that triggered the notice, as represented by change report 160. Note that similar pattern recognition processes may be used to identify noteworthy patterns or trends in the PIP as well as to generate change reports, as described further with reference to FIG. 5.

Change reports and triggers for change reports may include the following. Change reports providing background checks on

employees and delivered to an employer;

spouses and delivered to a spouse;

business partners and delivered to partners;

principals of competitor organizations and delivered to competitor;

students and delivered to headmasters;

parolees and delivered to parole officers or court clerk;

neighbors and delivered to neighbors; etc.

Change reports may be generated and transmitted to subscribers

On a periodic basis;

In response to changes detected in consecutive PIPs;

In response to specific criteria such as the appearance of a criminal record or civil judgment;

In response to specific events; etc.

Change reports may include

Only changes from one report to the next;

All information normally in a PIP, but highlighting changes from one report to the next;

All information normally in a PIP, but highlighting changes and/or content considered relevant according to subscriber's personalized policies such as an interest in only legal issues or financial issues related to the target;

Only certain classes of information, such as legal and financial, but all information in occasional reports.

Change reports may be delivered

On mobile devices;

In email by way of a link or included in content;

By mail, telephone or other medium.

The above are provided as examples to make the concept of the change report clearer and are not intended to limit the invention.

FIG. 5 illustrates a system and method for generating an augmented public information profile report in which questionable information is fixed and/or annotated. A profile form 105 is filled out by the user as in the embodiment of FIG. 1A and a query process 325 generates a report form 315 which contains a PIP with a form for feedback. The form may be integrated into the PIP, for example form controls in an html-delivered PIP format. The report form 315 is designed to allow the user to indicate questionable items in the PIP. For example, each data item may be provided with a check box or set of radio buttons to indicate that the data item is believed to be wrong for some reason. The report form 315 may include multiple iterations (a second html page, for example, in response to the user submitting the first form) to request further information about the supposed errors. For example, the second form 315 may ask whether an address that was flagged by the user in the first form 315 was the wrong address or contains a typo. The first form may include controls to allow the user to indicate that a data item is missing, for example, an old paid up mortgage is not listed.

When the query process 325 receives the form 315 and any further iterations of it, it generates one or more queries of the primary sources 125 associated with the data that were indicated as erroneous or incomplete. The box labeled primary sources 125 may be viewed as encapsulating any access devices such as a web-interface to allow queries to be satisfied. Many governmental organizations provide such services for free. But a manual search may also need to be done. With the additional data from the primary source, the query process 325 generates a new fix report 305 that contains both the secondary source data and the primary source data, preferably in juxtaposition for comparison. The fix report may contain only the flagged data items or it may be a complete PIP with the additional information shown. Preferably, in a complete PIP, the verified data items are highlighted, such as by using a colored background.

Information indicating noteworthy or otherwise significant information can be derived by making comparisons and/or detecting patterns in data from multiple sources such as:
Comparing data from a database with lesser authority with one with a greater authority such as comparing a secondary source with a primary source, to determine if a source may be wrong.
Looking for inconsistencies among data, including direct inconsistencies (such as above) and indirect inconsistencies. An example of this is where the demographics of user are inconsistent with recent purchasing patterns. E.g., a young accountant with a family purchases aftermarket auto parts at a bricks and mortar retailer far from the user's home address. For another example, if certain data tend to change at the same times: the telephone database should indicate that a user's phone number has changed when the address changes, for example, and when it hasn't it's something that should be flagged in the PIP, change report, and/or alert. Yet another example is where different primary and secondary credit or merchant databases show instances when a “most recent” address for a name (with or without an Social Security Number and other identifiers) does not match from one data source to the next.
Structural defects in data such as failure of uniqueness, such as more than one name associated with a Social Security Number or similar clusters of information that would indicate multiple instances of a an individual, for example identical name and age living at a single address at one time, but residing at more than one address at another time.
Identifying data held by entities with known past instances of fraud such as massive theft of loss of information. Additionally, data storage entities that are popular targets of data theft or known to be vulnerable to data theft. For example, a large multinational bank may be a more common target for hackers than one with a purely local presence and difficult to access extraterritorially.
Classifying data associated with a user according to known patterns of fraud liability. For example, demographic data of a user may, statistically, be associated with a higher incidence of fraud, for example addresses. This could happen where the trash of wealthy residents is a known target of dumpster divers looking for sensitive documents that have put in the trash. Classification can be constructed using known collaborative filtering techniques, based on diverse sources of information even as divergent as voting records and census data. Although such records may not be updated frequently they can be used to generate classifications for users that are persistent. Data classification may be fuzzy in nature, and not a black and white indicator. For example, an examination of cell phone databases might indicate that a unique individual has more than one cell phone. While not a indicator of fraud by itself, it is noteworthy and, if combined with other information, it may provide a strong indicator of fraud or identity confusion problems.

FIG. 6 shows a complete PIP 370 illustrating an embodiment of the report form 315. A check box control 345 is shown as an example in the Asset section's real property section 365 adjacent an address 355. Also shown is a text box control 346 for the user to enter a comment about the particular piece of data, here, the address in this example. A user may check the check box and enter text in the text box control 346 and submit the form 315 which is then processed by the query process 325. Other records and other information are indicated elliptically at 386, 390, and 395 including data sources accessed 375. The embodiment of the PIP 370 may be implemented as an html form so that it serves as both a report and form.

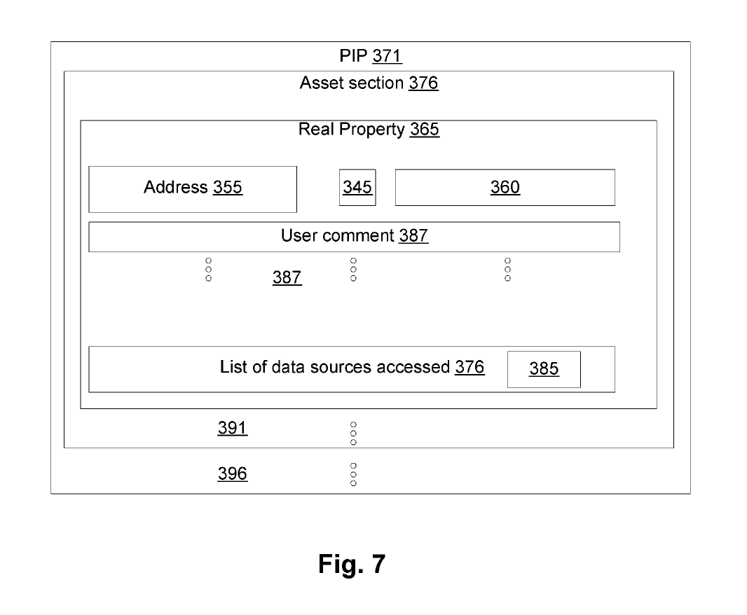

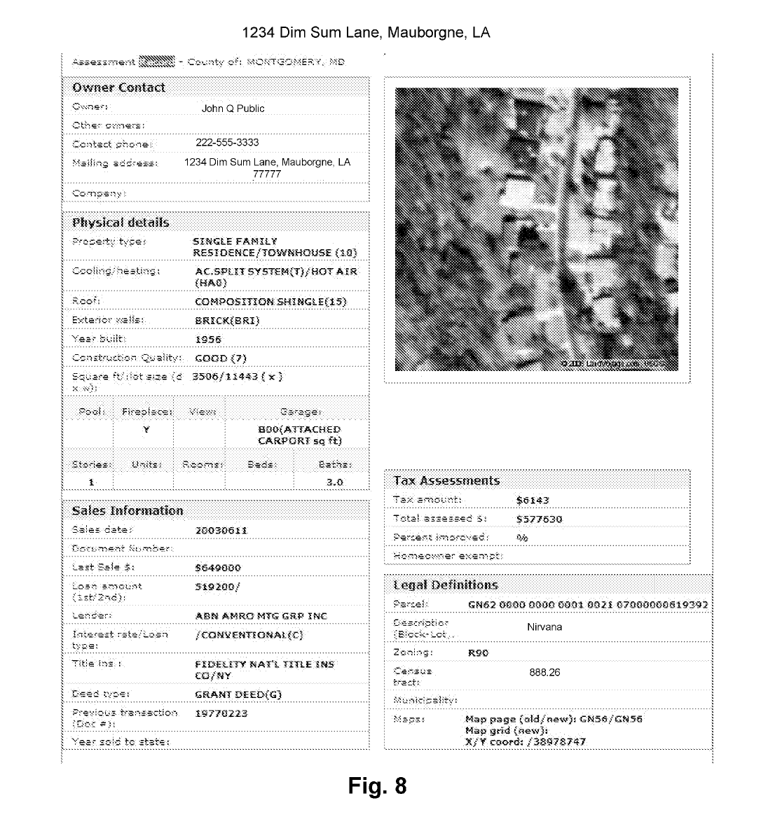

FIG. 7 shows a complete PIP 371 illustrating an embodiment of the fix report 305. As in the previous embodiment, it contains an asset section 376 with a real property section 366 with address information 355 of the report form 315 embodiment. Juxtaposed with address information 355 is address information 360, which originates from the search of the primary sources 125. The user's comment 397 also appears in a manner that associates it with the information that was questioned. In addition to a Highlighting 380 may indicate that information in the PIP 371 includes information that is revised, for example as shown here, the address information 355 and 360 are highlighted 380 to indicate that the additional address information 360 has been provided. Also, the additional source of information 385; i.e., a direct query of the original source, may be shown in the sources listing 376.

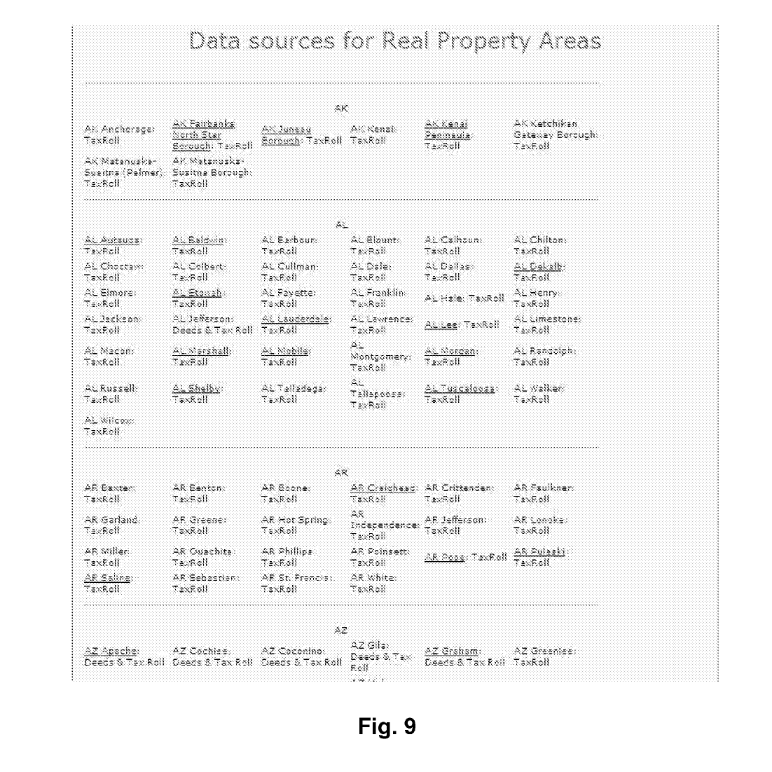

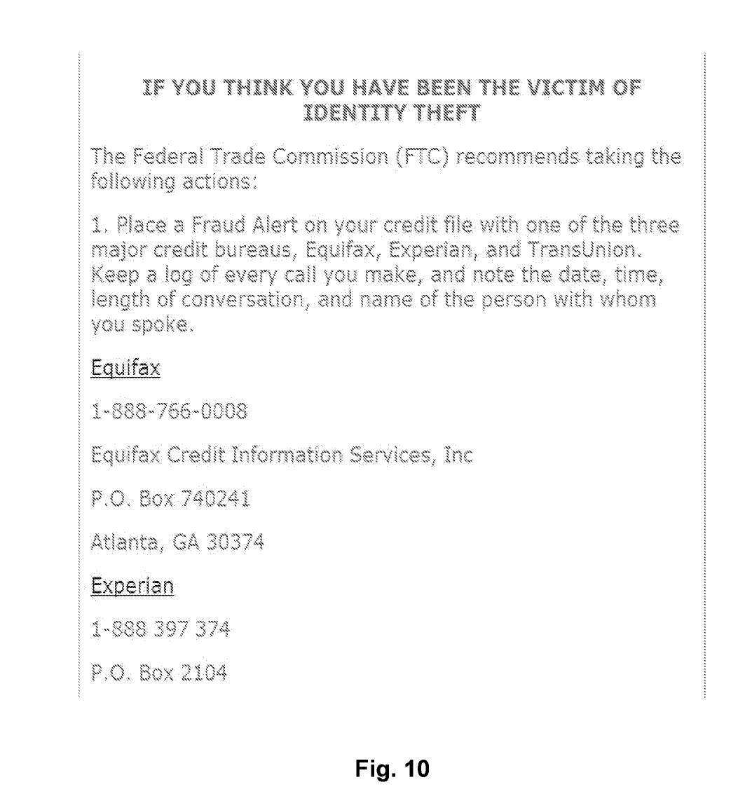

FIG. 8 shows a portion of a PIP embodiment relating to real estate residences purchased. This is a snapshot of what might appear in section 270 in the PIP 248 illustrated and discussed with respect to FIG. 2B. FIG. 9 illustrates a portion of an embodiment of a list of data sources accessed. This is also a snapshot of what might appear in section, for example 276 or 284, in the PIP 248 illustrated and discussed with respect to FIG. 2B. FIG. 10 illustrates helpful information (e.g., as indicated at 292 in FIG. 2B) that may be included in a PIP.

FIG. 9 illustrates a portion of an embodiment of a list of data sources accessed. This may be provided as part of the PIP or in a separate document. It shows all data sources grouped and ordered by region for each category of data. For example, the illustrated one is a portion representing data sources for real estate information.

FIG. 10 illustrates other information that may be included in a PIP including instructions for what to do if certain kinds of false or misleading data are identified automatically or by the user. For example, as shown, contact information to allow the user to file a credit freeze with the three major credit bureaus may be provided. Other information and web controls may also be provided as described elsewhere in the present specification. Preferably such information is shown in the PIP itself with web navigation controls to make a long report convenient to review.

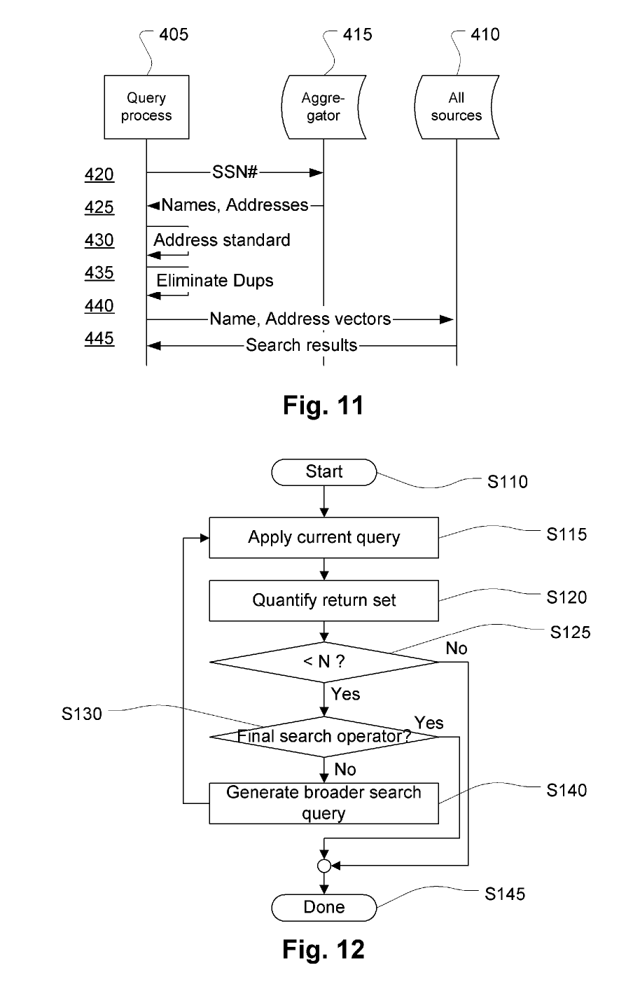

FIG. 11 shows an example process for searching a database in which the search query is made broader by an iterative process that derives alternative search criteria. A query process 405 generates a query as indicated at 420, for example, one including only a social security number to search a first database 415, in the present example one provided by an aggregator 415 of diverse primary data sources. The result of the first query is further information connected to the social security number. In the example shown, the further information includes names and addresses as indicated at 425. These may include a variety of names and addresses if the name has been misspelled, was changed, or a number of formats are used. The addresses and names may be run through a standardization process of filter 430 to conform the names and addresses to a standardized format to make essentially identical addresses appear the same. For example, the post office provides such a filter for addresses. The duplicates are then eliminated in the list of names and addresses as indicated at 435 and the resulting list used as alternative query vectors for searching all the searched databases, including primary and secondary sources 410. The search results are then obtained as indicated at 445.

Note that the embodiment of FIG. 11 is not limited to names and addresses. Other kinds of search vectors may be used, such as driver's license number, biometric data, etc. Also, the filtering and duplication-elimination processes may be eliminated or altered to allow for misspellings in the records of the databases. The aim of the process of FIG. 11 is to obtain all the possible records associated with the user. Also, although the process is illustrated as querying an aggregator database with a first query and then querying other sources 410, it is possible to query primary sources and then aggregator sources of information or primary first and then, based on the result, aggregator databases.

FIG. 12 shows a process related to that of FIG. 11 for iteratively broadening search criteria until a target goal number of records is reached. At a first step S115 after starting the process S110, a current, initially narrow (strict), query is used to search a data set. A return set is obtained and the number of records counted at step S120. The number is compared with a goal N at step S125 and if it is lower than the goal it is determined if the search can be broadened (made less strict) at step S130. If so, a broader search query is generated at step S140. If not, the process terminates. Also, if at step S125 it is determined that the goal number of records has been obtained, the process is also ended S145. An example number for N is 30. Note that the number N may not be a strict cutoff such that if the number of records returned using a relaxed criterion exceeds N but is close to it, while the stricter criterion produces a very low number or none, the result obtained from the relaxed criterion may be used. It is preferred thus, that no records be excluded on arbitrary grounds to satisfy a numerical requirement. Also, more than one database may be queried in the process of FIG. 12. For example, rather than expanding the query, the process may include querying other databases which may contain, for example, less preferred data, in an effort to reach the goal number of records. This could include or replace in step S140, linking to another database such that the group of databases queries is iteratively expanded until N is reached.

The goal number of records N may or may not be a fixed parameter for all users in all instances of use. For example, N could be based on how common the user's surname or first name is. This could be determined via a lookup table of names. In addition, the process need not be literally as illustrated. Many algorithms for achieving the result of a target number of records may be employed, for example starting with a moderately narrow query and iterating toward the goal from a level that is too high or too low. Examples of broad and narrow queries can be generated from partial information, such as last name plus first initial, or addresses that include street name without the street number. In addition, or alternatively, the queries could include misspelled alternatives or other kinds of fuzzy search strategies. The alternative strategies may include retrieving a maximum data set in a single query and reducing the number of records based on the narrow and broad query criteria in a local process. In that way, the external database only has to be queried once and the retrieved dataset can be efficiently sorted and prioritized using the narrow-to-broad query criteria.

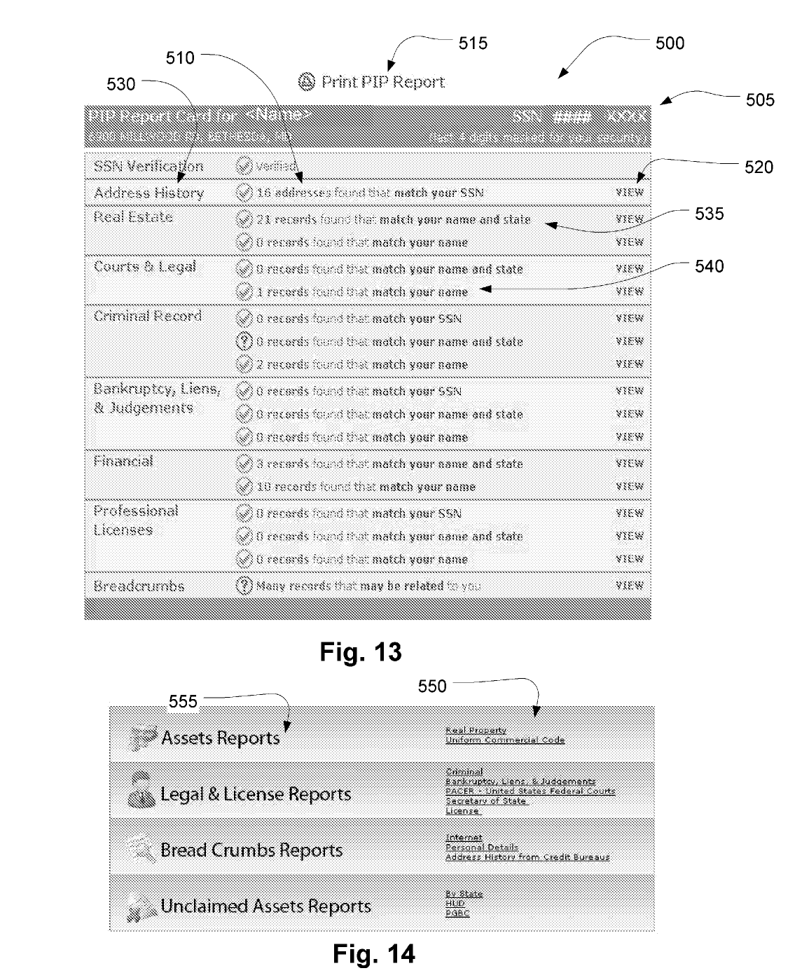

FIG. 13 shows an embodiment of a portion of a public information profile (PIP) which summarizes the contents obtained. The portion, a header and navigation area 500 of a web page, for example, generated dynamically from the search result, includes a print control 515. Each of multiple sections, for example one indicated by a category label 530, correspond to a category of information returned by the search. Indicated alongside the category label 530 is a phrase (e.g., such as at 510) indicating the number of records found and information about the search, for example, the criteria used in the query. In the first example indicated at 510 16 addresses were found in the address history search by matching against social security number. A control to view the results is indicated alongside the portion 530 at 520. Other examples of criteria are indicated at 535 and 540. A header part 505 identifies the subject of the PIP. The header 500 may appear at the top of a long report which may appear as a single web page that is dynamically generated.

FIG. 14 shows an embodiment of a portion of a public information profile (PIP) which provides links to different portions of the PIP. This is an example of a navigation control in which all the different sections are grouped by a broader category such as indicated by the label 555. For each broader category, a link (such as indicated at 550) for the portions of the report corresponding to each of a number of narrower categories are also provided. Preferably this navigation tool is shown at the top and links provided to it (or it is duplicated) at various parts of the report, which in practice, could be very long.

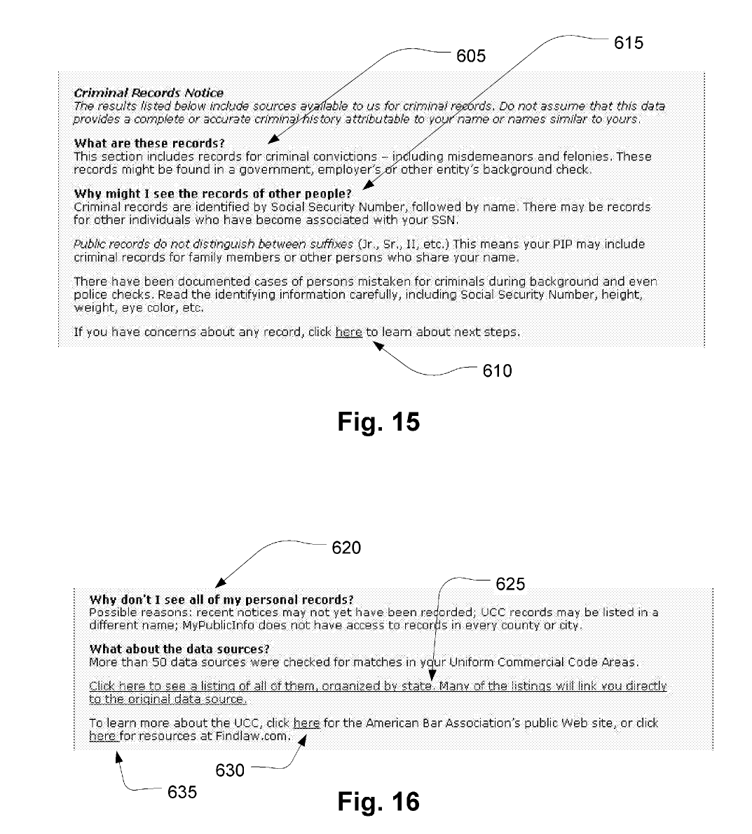

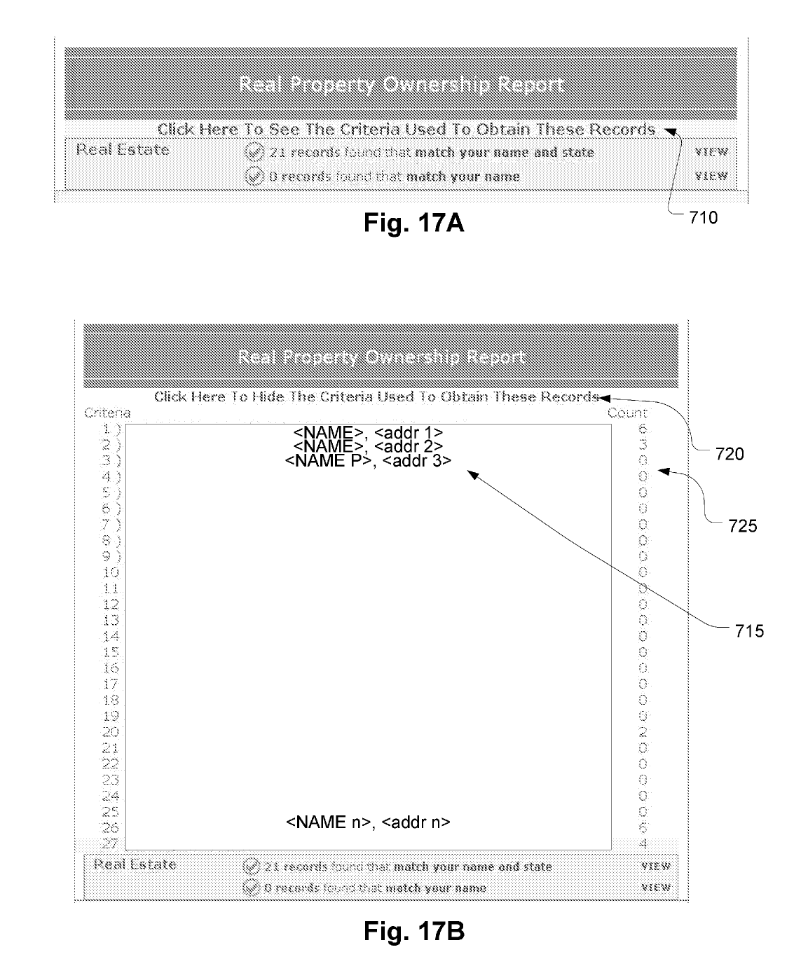

FIG. 15 shows an embodiment of a portion of a public information profile (PIP) which provides information and link controls for assistance regarding certain elements of the PIP. For each section of the report, various pieces of relevant information may be provided such as indicated (and self-explained) at 605, 615, and 610. In a preferred embodiment, a more detailed explanation of the nature of the records is shown in the corresponding section close to the corresponding group of records. This is a navigation expedient; namely, distributing the key relevant descriptions among the records in the report. Description and other information which are deemed key in the preferred embodiment are a detailed explanation of what the records are, where they come from, and why the records may include unexpected results. A short FAQ may appear in this same location. Similarly adjacent each record group, as in FIG. 16, information and link controls for assistance, such as indicated (and self-explained) at 620, 625, 630, and 635, regarding certain elements of the PIP may include an expandable list of data sources, or as indicated in FIGS. 17 A and 17B an expandable list of criteria used to generate the search results may also be provided. Although it is preferred that this information and these controls be distributed in the report as shown, in alternative embodiments they may be provided in a single location in the report or on a separate page, which may be programmed to open in a separate browser window or browser tab.

FIGS. 17A and 17B show collapsed and expanded views of criteria used to show records obtained (a similar embodiment may be included as well to show information about the sources of the information). FIG. 17A shows the list of criteria in an unexpanded state and 17B in an expanded state. The features are indicated (and self-explained) at 710, 720, 725, 715. The criteria 715, as discussed above, may include various alternatives of similar (overlapping) information such different references to the same address and the count of results. Queries that produce negative results are also shown by the column of records returned counts indicated at 725.

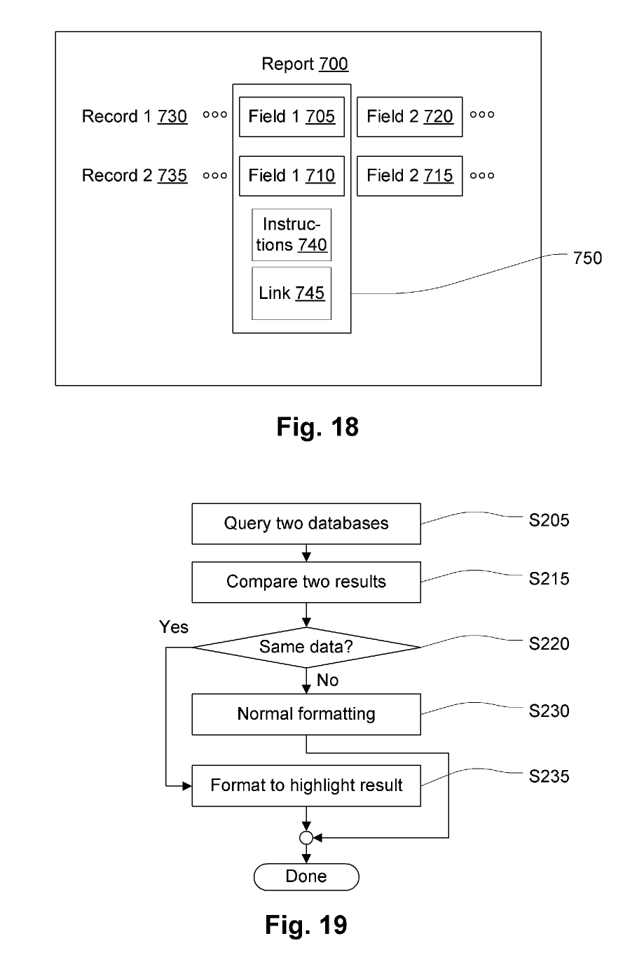

FIGS. 18 and 19 illustrate a PIP format feature that helps users understand when discrepancies may arise between one or more data sources and how to cure them. In FIG. 18, a report (PIP) 7000 contains two records, each determined to pertain to the same person, event, or thing. For example, both can represent the same house. However, the records are not identical in content and contain contradictory information, such as who the owner was or whether a lien exists on the property. The contradictory information, indicated as Field 1705 and Field 1710 are formatted so that they are juxtaposed for easy comparison. To further highlight the contradiction, a highlight 750 is added such as a colored box, a border, or some other means. Also included is an instruction for responding to the discrepancy indicated at step 740 and a link to a site with further information for responding or further information about the problem, indicated at 745. Note that discrepancies can be shown without special formatting just by including otherwise identical records in the PIP.

Discrepancies can arise for example where a data aggregator makes a transcription error when copying information from a primary source. Also, when a record is not updated after a change of status, for example the title is not changed after the sale of a fractional interest in a house to a remaining spouse following a divorce. In FIG. 19, a process for identifying similar information and formatting the results for easy comparison is shown. In step S205 two databases containing information pertaining to a same person, event, or thing are queried and the results compared at step S215. At step S220, it is determined if information in the records pertains to the same person, event, or thing. For example, if the information relates to an address, the addresses are compared to see if they are the same or similar. Then, at step S230, if the comparison indicates the results pertain to the same person, event, or thing, normal formatting is applied at step S230 and in the alternative case, special formatting is applied at step S 235. The latter may include the addition of instructions and/or links as discussed with reference to FIG. 18.

The kinds of uses of a PIP or change report and the other services discussed above are many and varied even though we have emphasized personal identity protection. As noted above, all the features discussed with respect to a “user” may be provided to a third party where the user is the target of the information search but the recipient is a third party. Examples of third parties who might use such a system, such as the change-report system of FIG. 4, for example, would be employers who wish to know of any information that might case an unfavorable light on an employee. Other examples include spouses interested in monitoring their spouse, patients monitoring doctors, business owners with regard to their business relationships, customers, etc. The examples are too numerous to list.

While there are known methods for evaluating the likelihood that fraud has occurred or is about to occur in various situations, most of them are processes that support and protect businesses, not individuals and fall within the class of processes known as data-mining. This area is known as fraud detection and they are of interest to banks and insurance companies, to name examples. Devices include predictive models of when fraud has occurred, or is about to occur, to allow businesses to respond, such as by locking a credit card or bank account until the owner confirms a transaction.

With regard to individuals, it is possible to subscribe to a service that alerts consumers to possible fraudulent activity related to their charge accounts. To help consumers anticipate how their behavior may affect their susceptibility to fraud, there is only good advice. As part of a service for overall identity protection, a method of predicting susceptibility of an individual to fraud and giving the individual an opportunity to proactively change his personal circumstances and behavior and external circumstances to reduce it.

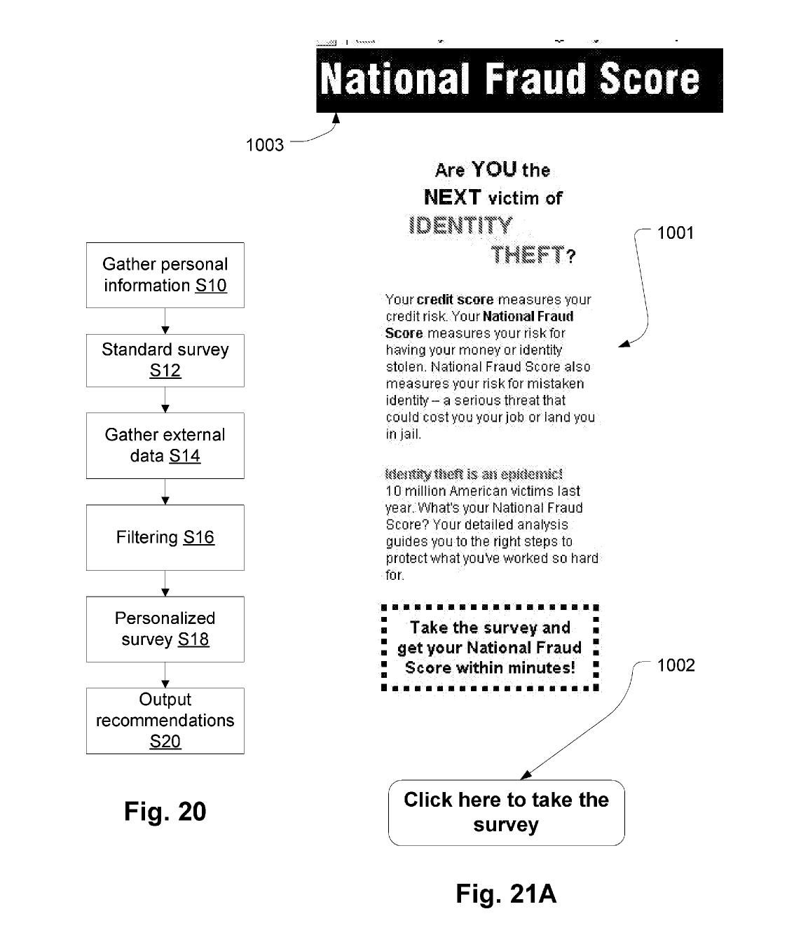

Referring to FIG. 20, a method is described for generating and outputting guidance to individuals as to how they are adding to their own risk of identity theft and what they might do to reduce their risk. In a first step S10, personal information is gathered from the individual through a individual interface to generate a personal profile. The personal information includes identity information but also information relating to the individual's circumstances such as the nature of employment, kind of habitation (individual home, apartment building, condo, etc.), uses of credit, etc. The profile may also take up information to provide access to secure accounts and reporting services such as credit reporting agencies, only banking and credit card accounts, etc. from which further personal information can be derived, such as determining how the individual uses the individual's credit card and spending patterns.

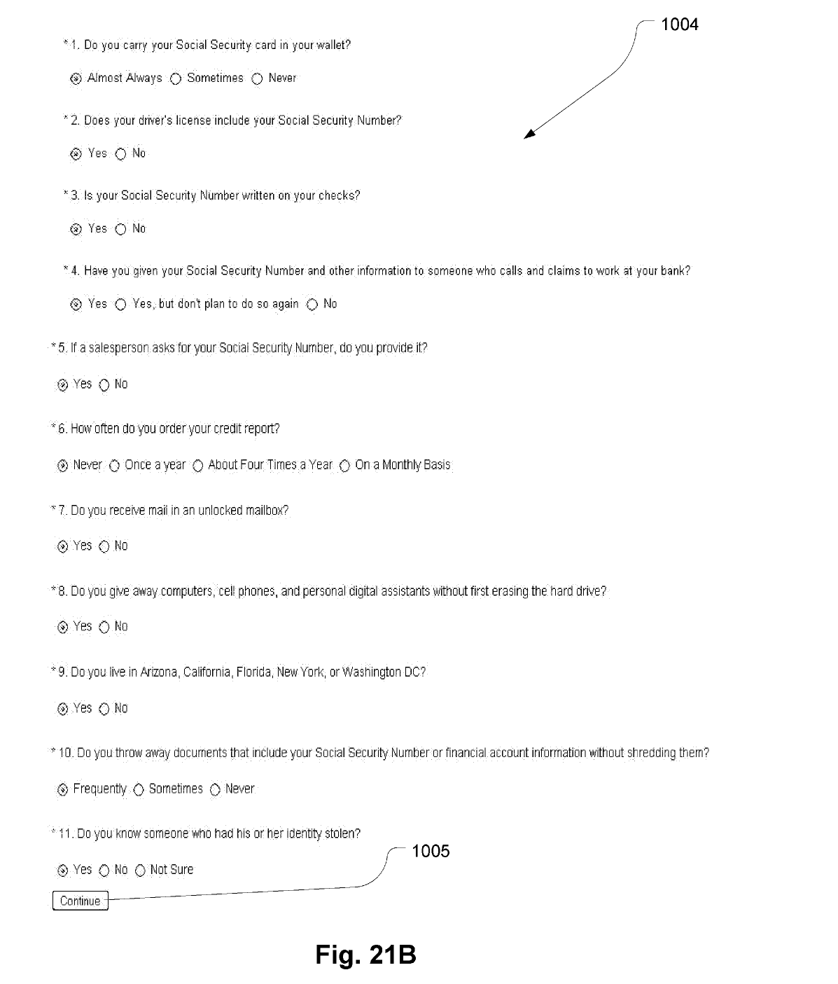

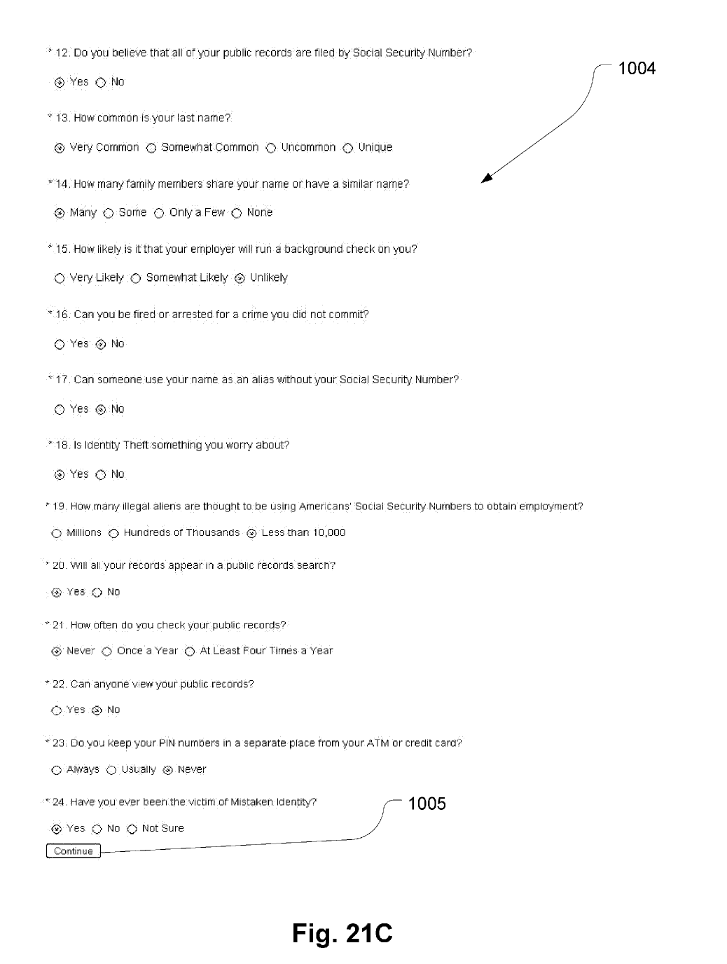

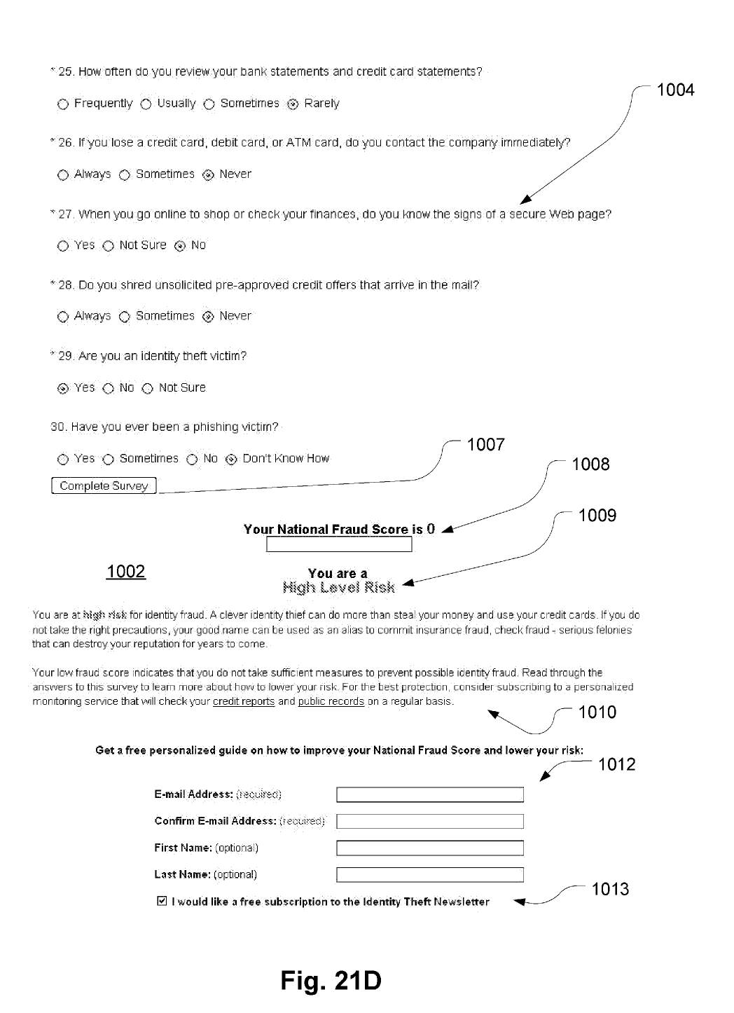

In a second step S12, a standard survey may be generated to gather further information to help in characterizing the individual's patterns of behavior, circumstances, beliefs, knowledge, etc. The purpose of the standard survey is to determine information about the individual that can help to generate a predictor of the individual's risk of becoming a victim of fraud in the future. To make this step more clear, an example of a survey, including specific questions, is shown in FIGS. 21A, 21B, 21C, and 21D.

In FIG. 21A, in a web site implementation, banners 1001, 1003 provide the individual an explanation of the purpose of the survey and an explanation of a score the individual will receive in response to the survey. A control 1002 grants access to the survey contents. A series of questions follows, in the present example, multiple choice questions 1004, which are answered in groups. Upon completing each group of questions, a control 1005 advances the individual, ultimately, to a final screen 1002 in which a score 1008 may be generated. A narrative explanation of the score and summary advice 1010 may be provided. If the survey is a stand-alone feature, the individual may be given the opportunity to opt-in to a newsletter or other service by means of appropriate controls 1012 and 1013. A stand-alone feature might be one which includes on the step S12 and S20 (to discussed further below) an available through an online account management portal such as a bank or credit card.

A variety of different questions may be provided. The above list is an example, only. In step S14, external information is accessed using personal information and identification information. This may include one or both of authentication data to access non-public information and information available in public databases, such as discussed above in connection with the PIP. In the case of private information, the system may log into personal accounts and download transaction information. This may be filtered to generate information that can be more easily obtained this way than by the survey of step S12 or which may be more objective and concrete than answers to questions. The purpose of the step S14 is simply to gather further information about the individual which may be used to create a prediction of how susceptible the individual is to identity theft or credit fraud and to compare the elements that factor into the prediction to recommended guidelines and personalized recommendations. For example, the state of residence may indicate how easily fraudulent identification such as a driver's license can be obtained, with some states requiring a waiting period and central issuance and others requiring on the spot licenses. Another example is the practices of the individual's employer, credit providers, academic institutions, state organizations, political organizations, etc. as indicated by known their practices or incidence of loss or theft of personal employee information or computer hacking associated therewith. For example, the individual's employer may be known to have lost private information of its employees. Such results may be used in creating a score in step S20.

The standard survey information can be compared to the information obtained in step S14 to determine if there are discrepancies and thereby determine a reliability of the survey results. If there are substantial discrepancies, certain survey information can be discounted. For example, if the survey asked whether the individual has high credit limits on credit accounts and the information “scraped” from the individual's accounts contradicts the assertion, the objective information may be used and the survey response ignored. Discrepancies themselves may be helpful as a predictor of certain behavioral factors that generate the risk of fraud or identity theft, such as a lack of knowledge about the individual's circumstance. For example, in the example mentioned, the fact that the survey indicated incorrect information may suggest the individual doesn't know about the account credit limits. The reason this makes a difference is that accounts with high credit limits are more attractive targets for fraud and a person who is careful about identity theft risk would be more likely to know about such a risk factor. Publicly-available information gathered in this step, such as how common the individual's name is, are also useful indicators of the risk of identity theft and/or credit fraud.

The considerations of what can be gleaned from the information gathered in steps S12 and S14 leads to the next step of filtering S16.

In step S16, the system may take the information gathered in steps S12 and S14 and combine them with further information from many other sources indicating trends associated with patterns detected in the information unique to the individual concerned. For example, the technique of collaborative filtering may be employed. The further information may come from a database covering instances of identity theft and/or credit fraud correlated with the circumstances of such instances. The further information may be distilled data that is stripped of personal information and reduced in some fashion to permit rapid computer processing. Still another example is credit header data, obtained using Social Security Number, indicating a frequency of address change. Step 16 may include simple data integration, such as using a correlation between incidence of identity theft and/or credit fraud and the zip code or state of residence of the individual.

The techniques for such processes are well-known and continuously undergoing improvement so further explanation should not be required. The outcome of step S16 is set of information characterizing the individual of concern in terms of identity theft and/or credit fraud.

This information may be used in a further step at S18 in which certain additional information is requested. This step is desirable because a standard survey as in step S10 may cover issues that are of little concern to the circumstances of the individual user. For example, shredding of documents by a user who has not recently lived in a multiple-dwelling structure, such as an apartment, may be of lesser concern in terms of predicting risk of identity theft and/or credit fraud, than one who has lived in a single-family house. This is because dumpsters of multiple-unit dwellings are generally considered more attractive targets to “dumpster divers” seeking personal information from documents in resident's rubbish. So in step S18, still further, generally more detailed information, specifically tailored to the individual's circumstance.

The final step of the process of FIG. 20 S20 may be the generation of a fraud score metric and/or personalized advice and recommendations for what the user may do to reduce the individual's risk of identity theft and/or credit fraud. The process of FIG. 20 may include all or only selected ones of the steps shown. For example, the fraud score could be generated from just a standard survey as illustrated in FIGS. 21A-21D.

Note that the fraud score is intended to be a standard measure that is numerically pegged to an objective referent, such as the likelihood of an individual being a victim of identity theft or credit fraud in a specified time period. In this way, as better predictive tools become available, the meaning of the score does not change, although the value may. Also, the score could become a standard for the identity protection field and allow other parties to provide predictions using other devices and metrics. Note that instead of being a simple predictor of likelihood of identity theft or credit fraud in a specified time period, the score may be discounted by the severity of the adverse event. For example, having a credit card account raided is not as serious as having one's Social Security Number stolen, since there is a limit to how much a consumer is liable for when their credit card is misused but much greater risk, such as wholesale impersonation, when typically secure identifiers are obtained by third parties.

The previously-discussed PIP, or personal information profile, may provide a model and support for additional information products for use by primary and third parties. Examples of targets of such information summaries are charitable institutions, scholarship institutions and other grantmakers, nonprofit organizations, businesses, etc. There are information aggregators that comb just financial information from Internal Revenue Service (IRS) Form 990, for information that may be useful for indicating the health and efficiency of such institutions. But the principles employed in the above-described PIP can take such reporting much further. This may be accomplished by scanning additional sources of information as well as by employing search techniques such as discussed above with reference to FIGS. 11 and 12. The additional information sources may include:
IRS Section 501 lists or other indicating tax exemption status;
For the business and/or each Principal involved in managing the institution or company or the Board of Trustees, large donors, and other significant parties, each of the following may be generated:
A PIP (which may include) . . .

A search of terrorist watch lists such as that of Office of Foreign Assets Control (OFAC);

Credit header data;

Annotations made by the targets of the information search (such as annotations that are permitted by credit agencies to be attached to consumer credit reports);

Milestones such as Formation, hiring, changes in funding vehicles (e.g, big investment purchases or sale), restructuring, hiring of principals, changes in assets; cumulative funding disbursement threshold, etc.;

Newspaper articles and other publications such as web sites.

In addition to providing detail reports in the manner of a PIP, the institution reports may include lump parameters or metrics of interest to certain parties. For example, for charities, the profile of supported charities may reduced to, for example:
green score (the ecological sensitivity of the institution's activities or beneficiaries);
human rights score (the human rights sensitivity manifested by the institution's activities or sponsorship of beneficiaries);
political bias score (does the institution manifest a political bias and if so, in what sense);

Such metrics can be derived by associating beneficiaries or activities (the targets) with a score in a lookup table and then, using the profile of targets to create a statistic, such as an mean or mode value or a histogram of values (cumulative total with a given score) that would be displayed.

Because of identity theft and credit fraud, a number of database providers have provided individuals the ability to opt-out of their information lists. In some cases this has been statutorily mandated and in some cases it is voluntary. These databases include secondary data aggregators such as search engines and other examples discussed above. Concrete examples include membership lists, telephone directories, and others such as listed above in connection with the PIP system. An existing product available today allows consumers to subscribe to a service that will regularly search for information about the subscriber and determine if the subscriber's personal information can be deleted or blocked by the server. Basically, the service does what a person would do to cancel public access to his/her information. Such a system is described in US Patent Publication 20050198037, which is hereby incorporated by reference as if fully set forth herein in its entirety.

A drawback of the current technology is that a subscriber does not obtain feedback on which databases were contacted, and the level of success relative to each. Basically the service provider simply promises to do its best. In the above-incorporated patent publication, confirmation of successful removal of an entry is determined, but the success or failure is not reported to the subscriber. The only feedback provided is in the vein of: “We checked over x hundreds of sites and discovered y number of likely matches to your personal information,” which is provided only to prospective customers as a teaser to help close the prospective subscriber. Another shortcoming of the system is that there is no provision for restoring information previously blocked.

In an embodiment of a similar system, a subscriber is provided complete control over deletions and changes to his or her personal information and notifications of changes. The concept is similar to the embodiments described above, for example with reference to FIG. 5 except that in the present embodiment, opting out of databases is supported. The following control panel features may be combined with the elements discussed with reference to FIG. 5 as well.

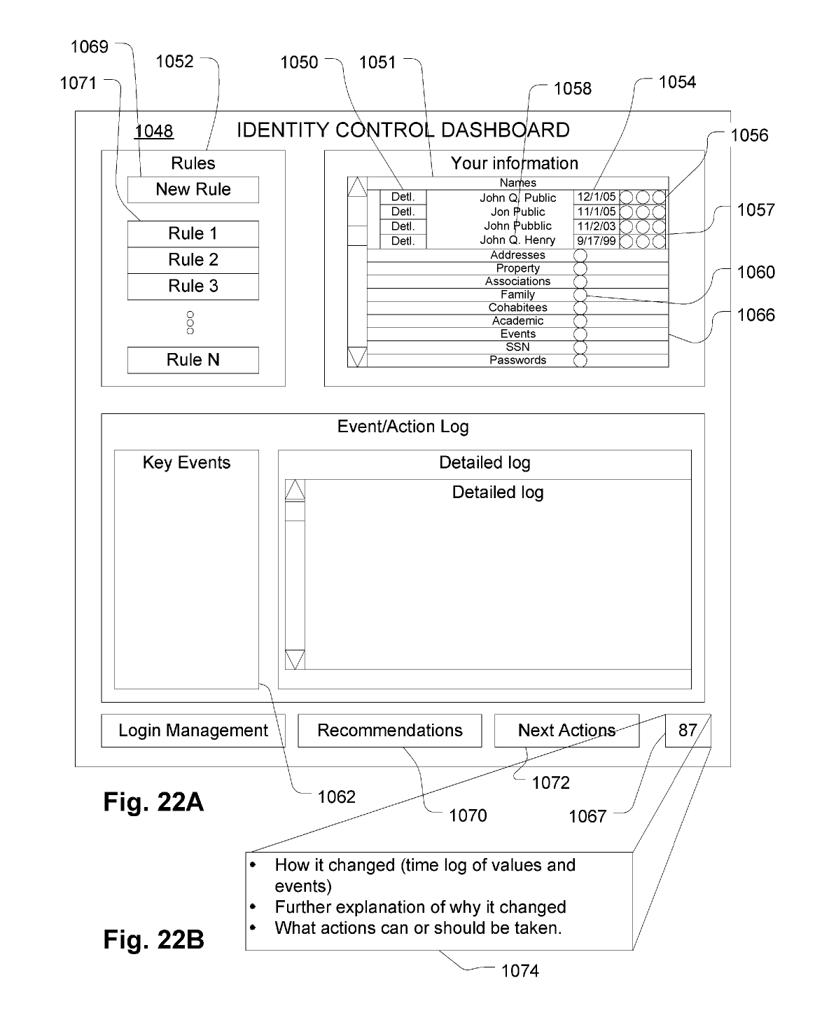

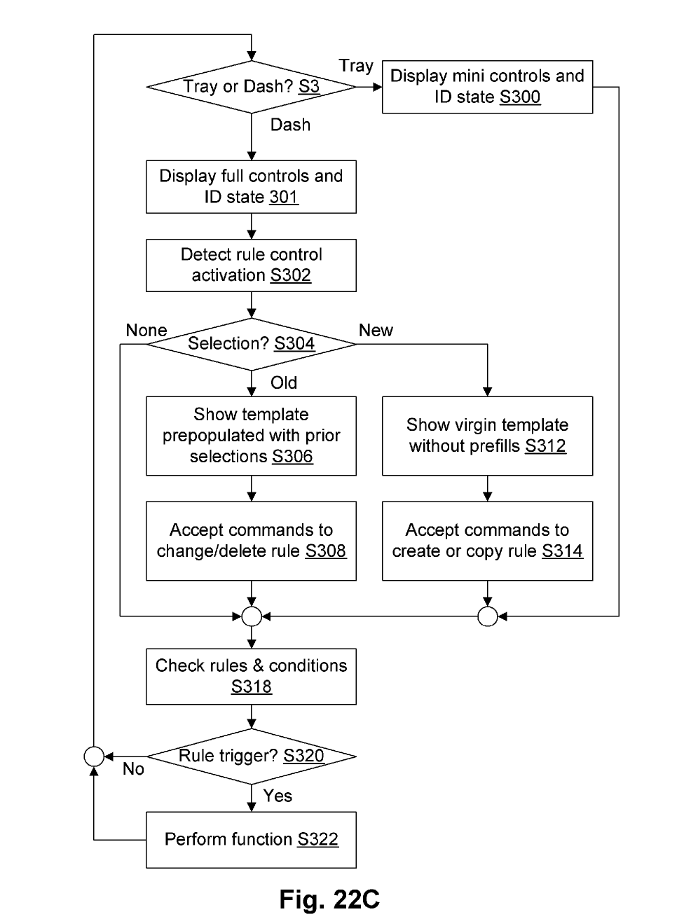

Referring to FIGS. 22A and 22B, an example of a user interface that brings together many of the features discussed in the instant specification is shown. The user interface display 148 shows various controls as may be provided by a web browser. A rules area 1052 includes controls to allow a user to add, modify, and delete rules that control how the service treats personal information. Examples of rules are ones that specify the timing and/or frequency of changes, or make subject matter limitations such as that only information that provides a physical address corresponding to the target's name should be blocked or that the target's information should be blocked from all non-English-language sites. Other alternatives include requiring that the target's information should be blocked for a specified period of time, only, and then be restored. The rules may be entered in a manner such as provided by the mail blocking interface of many email clients, for example as discussed in U.S. Pat. Nos. 6,101,531, 6,249,807 and as provided by the “Organize Inbox” feature provided in Microsoft Outlook. That is, sample rules may be provided with selectable fields. For example, calendar controls may be provided to enter dates or Boolean operators may be cumulatively applied to selected fields (name, address, zip code, English-language, etc.) to provide an action (opt-out, restore, correct, block, even add data to a database not already containing the individual's personal information, etc.) that is also selectable. Alternatively, rules may be entered in natural language and a server side process used to translate them into templates which are shown to the user for confirmation. Natural language techniques are well known and continually undergoing improvement and can beneficially used in such an interface.

An information area 1051 displays samples of information obtained from various sources and its current status, for example, an indication whether the data was changed, blocked (Note in the present context, blocked, opt-out, and deleted are considered to mean the same thing), left alone or an attempt was made to change or block the information and it was unsuccessful. In the example shown, names 1058, in multiple variations, are shown in a scrollable window appearing in an expanded region indicated at 1057. Dates may be provided to indicate when the data was obtained. A summary status control may indicate the status of the data such as whether the data has been left alone, corrected, attempted to be corrected, deleted, attempted to be deleted, etc. These may be indicated by color icons, for example. A summary icon 1060 indicating information that has changed recently may be provided for closed categories. Upon opening the closed category, the relevant piece of information may be identified by the expanded indicators 1056.

The other categories of information, such as addresses, family, academic information, etc. are shown in a compressed state (as indicated, for example, at 1066) such that they may be selectively expanded by clicking the category label, thereby presenting a scrollable list. Detail access controls are provided to generate a dialog that shows what database the information was found on, activity that occurred with respect to that source, associated information at that source, a link to the source portal if there is one, and any other information that may be relevant.

The score indicator 1066 may represent a system tray control (TSR) that displays a current fraud score and is updated regularly by a server application that derives the score and sends an updated value to the TSR application, thereby displaying it. The score indicator 1067 described immediately above may also provide a control, as is common with systray icons, to launch the dashboard application described with reference to FIGS. 22A and 22B. Also, or alternatively, activating such a control 1067 may generate a miniature log 1074 of previous values of the fraud score indicating how the value has changed, why it changed, and what actions were and are recommended to change it further.

The dashboard of FIGS. 22A and 22B and score indicator 1067 can be implemented through middleware, a browser or other already-resident application (zero-byte client), with corresponding support from a server application. Generally, everywhere web or network applications are described, the variety of different forms are contemplated, including middleware, html, applets, classic client-server, etc. Security may be provided by conventional techniques.

Referring to FIG. 22C, a process associated with the user interface features of FIGS. 22A and 22B is illustrated. First, a small application may display an indication of the fraud score or similar information as indicated above. In step S3, a server application that communicates with the small application or the dashboard, depending on which is active determines whether the small application is active or the dashboard is active. Again, either or both may be a PC application, middleware, pure HTML on a browser and generated by a server process, or any similar process. If the small application (tray) is the only one active, then it is displayed and updated and displayed (though it may already be displayed) to indicate the present value of the fraud score S300. If the large application (e.g., dashboard) is displayed or to be displayed 301, then the rule area 1052 control is checked to see if a rule control 1069, 1071 has been activated to add a new rule or edit/review an existing one, respectively. If no selection is made, rules and conditions are checked by the server or terminal application in step S318.

In step 304, if an existing rule is to be modified, a prepopulated template for making changes is activated in step S306 and commands are accepted in step S308 to make changes as required. In step S312, if a new rule is to be entered, a template for entering a new rule, which may include a natural language entry control as mentioned, is provided and appropriate commands accepted in step S314. Once the rules are saved with any modifications, in step S318 the rules and external conditions (for example date and time, time of year, other trigger event such as an alert (e.g., as discussed with regard to the mechanism of FIG. 4). If a rule (including a system rule other than one created by an individual) triggers it S320, the system perform S322 the opt-in, opt-out, change functions discussed above. The system may perform the functions in S322 on a regular basis if a general rule is provided for that. The system then repeats the loop by returning to step S3. The foregoing is a simplified for purposes of illustration and not intended to be limiting of the processes by which information addition, change, and/or blocking may be performed by the system.

A key event area 1062 lists events that may be of interest to the user, such as completion of a first set of deletions, a key data change, or the appearance of important information such as may be provided by the change report notification feature of FIG. 5 embodiments. An event log records detailed information about the activities on the subscriber's behalf and results associated with them.

A control to access recommendations based on various conditions detected by the service, including events related to the subscriber's personal profile (e.g, as described with reference to FIGS. 2-5) public or private information, external events such as a terror alert, or requests implemented by the user, is provided by a control indicated at 1070. A control providing access to a log of future actions that are scheduled to take place is also shown at 1072.

In the prior art, there are password managers that allow a user to log into a single portal or software application and from there access various sites or applications that require authentication. In the present embodiment, the dashboard interface beneficially combines password management with the above features. First, if the service is a trusted service, then subscribers may grant access to private information database services, such as employer web sites, academic web sites, association web sites, credit card and bank account web sites, etc. The service can look up and change information on these sites as well. And the service may provide keychain services such as provided by personal password manager. In this way, only one site needs to be trusted to obtain multiple benefits. Still another service that may be beneficially combined is to provide the user the ability to permit the system to automatically, and regularly, change passwords and login identifiers on the various web sites to make it harder for third parties to fraudulently access them.

At 1067, the fraud score indicator, such as discussed earlier, is continuously displayed. As the user's activities affect the fraud score, the score is updated by a process that regularly uses information such as discussed above and possibly the additional information available through activities using the dashboard embodiment of FIG. 22A. Clicking on the fraud score may provide an expanded display as indicated in FIG. 22B providing details on the score history and how it has changed over time.

Although the features of FIGS. 22A and 22B have been shown combined in a single dashboard embodiment, it is to be understood that each may be provided in a stand-alone interface or even as part of a stand-alone service feature or in any subcombination of the combination discussed above.

Note that although the opt-in, opt-out, and correction features of the foregoing may be performed using regular mail, if required. In database systems where automated telephone prompting is supported to allow subscribers or users to modify their status or in voice activated telephone systems, an automatic telephone client process may be used to perform this function.

There are a number of systems in the prior art that provide individuals, families, and agencies with information relating to the risks of crime. For example, in the area of sex offenders, a subscription service provides notification if a registered sex offender is within a radius surrounding the subscriber's domicile and alerts (such as by email) the subscriber if an offender newly registers. An example of such a service may be found at http://www.nationalalertregistry.com/, In the general field of public alert systems, US Patent Publication No. 2004/0225681 describes a system that allows information sharing regarding issues of concern such as crime reports, unfolding terror events, etc. among agency and individual subscribers. U.S. Pat. No. 6,567,504 provides a service that is similar but is mostly oriented to subscribers. Both of the latter two system allow subscribers to specify the types of information to be provided to the subscriber.

The value of systems such as described in the prior art are susceptible to dilution due to the pervasive problem of information overload. These systems fail to take account of relevance of information, except to the extent that they provide customizable information filters. They fail to include relevant information which may be more indicative of risks or pertinent to the concerns of the subscribers than the information which typical of the common chasm between actual risk and perceived risk. For example, there may be too much concern about a nearby registered sexual predator, and no concern at all about far more significant behavioral risk factors that correspond to the far more numerous cases where sex crimes have little or no correlation to the residences of registered offenders. The threats imposed by unregistered offender, offenders who move out and never re-register, and new offenders may pose a greater overall risk than those who are dutifully registered.

The procedures below, although they may be discussed in terms of offender registries such as sex-offender registries modeled on Megan's Law type legal structures, are also considered to be applicable, within the scope of the invention, to other kinds of registries or broadcast information which may not be persisted in a registry. For example, the Louisiana Amber Plan notifies the public of incidents being tracked by the police that are believed to involve a child abduction. In addition, news feeds and news web sites, or other news sources such as alerts, may be scraped for information on local abductions, sex offenses, and burglaries, and other crimes or possible crimes and records generated in a database maintained by the service provider. Such records may correlate John Doe type information (profile of possible or known offender who is not known by more concrete identifiers) when no suspect or convicted individual can be associated with alleged or actual offenses or patterns of offenses. All of the above databases and/or registries are considered to be usable with one, some, or all of the features described in connection with reporting and alert systems.

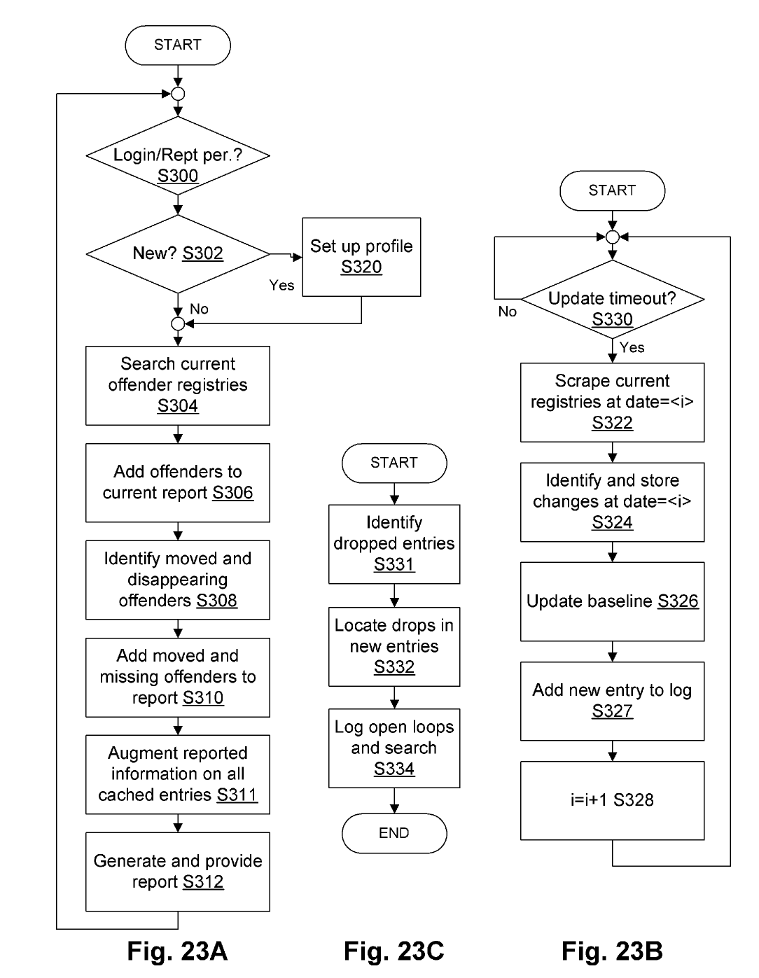

The inventors has recognized that techniques described in this specification for generating PIPs and change reports can be used, with other mechanisms, to address these shortcomings. For example, a procedure for adding information about offenders who have been lost to the registries of all states, is shown in FIGS. 23A and 23B. In step S300 a subscriber either logs in or a process for generating an offender report is initiated automatically. Automatic initiation may be the result of a regular reporting process or a subprocess that recognizes changes such as a new appearance in a subscriber's area of concern or the expiration of a regular reporting period. If a new subscriber is logging in S302, the user's profile is obtained S320, which includes various pieces of information that are used to generate the offender reporting information, alerts, etc. to be discussed below. For example, the profile information may include the subscriber's residential address, work address, commuting routes and means, shopping venues and other venues frequented, etc.

In step S304, the registries of all states or a national registry, if there is one, are searched using the user's profile information to identify offenders of interest. The profile information may also dictate which types of offender registries are to be searched and thereby limit the scope of the search. For example, a sex-offender registry may contain residences and names of offenders and the dates they registered. The available information is cached for purposes of generating a new report in step S306. In step S308 offenders who appeared in a registry at one time and who have subsequently failed to register again (missing offenders) are also cached in a separate area for further analysis. The search for missing offenders may not be limited in geographic scope since they represent known offenders who have failed to register and may be in the area of a subscriber without any indication in the offender registries. An illustrative mechanism for identifying missing offenders is described next.

Referring to FIG. 23B, in step S330, a decision is made whether to step through an iterative process to update information about missing offenders, identify new offenders, and create a log of other useful changes, which may be discussed later, that occur in the offender registries over time. For example, the decision can be based on the expiration of a regular data logging interval such as one week intervals. In step S322, the contents of all the registries of all offenders may be cached in a data store. In step S324, differences between the cached data and a baseline set of data which were stored in a previous iteration (step S326) are identified and stored. The stored data resulting from step S324 may include only enough data to derive the baseline from the current offender data or vice versa. Alternatively, a snapshot of the entire set of offender information may be stored in step S324, however this may not be preferred because it is expected that the cumulative contents of all the offender registries may change much more slowly than the reporting interval (triggered in step S300).

In step S326, a new baseline is stored so that the process can be repeated in a future iteration. The changes (differences between the baseline and cached offender information) at step S324 are stored in an historical log with date-stamps to permit the offender registry contents to be derived from it at any time. The process may also store entire offender registry snapshots so that every log entry does not have to be derived from an initial or current to an indefinitely remote point in time, analogously to the way MPEG video streams store I-Pictures, at intervals, the snapshots corresponding to the I-Pictures and the B and P-Pictures corresponding to the change information. The new baseline may contain the registry information cached in step S322. In step S327, the changes are added to a log. Step S328 indicates the incrementing of a date indicator. The process of FIG. 23B may provide a continuous history of registry contents which may be structured in many ways, such as by state and type of offense. Thus, a continuous log of offender information over time is generated by the process of FIG. 23B.

Returning to step S308 of FIG. 23A, the log of changes in the offender registries generated by the process of FIG. 23B may be filtered to identify any offenders whom the offender registries indicate are no longer contained in a reliable registry entry. Many state law require that the offender update their register entry annually. In such cases, a missing offender may be straightforward to identify. Referring momentarily to FIG. 23C, dropped entries are identified by comparing the registry entries at a current time with those at a time in the past. If a former registrant fails to re-register (identified in step S331 by cumulating and compiling a list of all registrants over time and comparing the list of all registrants over time with the registrants at a current time), if required, then the registrant is added to a list. In step S332, missing entries are identified. The steps up to S332 account for all moved offenders who were dropped from the global set of offenders at one time but added back to the global set at another time, in a new geographic location. The missing entries (“open loops”) are logged in a database in step S334. The missing entries in the log of open loops may be used as query vectors to search databases, such as those used for PIP searches as described above, in order to try to locate missing offenders. The additional information obtained from such searches may be stored in the log and added to reports as described below.

Note that whether a missing offender has been “found” or not may be a matter of judgment or may correspond to a imperfect prediction. For example, a PIP type search may yield one or more candidate results based on the identifiers that are available. If the available identifiers are solid, such as SSN, name, etc., and a unique PIP result is found which corresponds to all identifiers is found, the offender may have been considered to have been located. However, less than complete or ambiguous criteria and ambiguous results may appear in a search for a missing offender. However, such less-than-certain results may still be of use to subscribers since they may indicate the possibility of the presence of an offender. A report showing multiple possible finds of a missing offender may be indicated as such providing subscribers with an ability to take precautionary measures to suit.

Returning to FIG. 23A, in step S308, information is identified for inclusion in the report cache, based on the subscriber's profile which may include geographical information and preferences. Preferences may include whether to include the missing offenders at all, whether to include all, irrespective of the geographic information, if any, associated with the missing offender, whether to include only found missing offenders or both found and not found missing offenders, a reliability threshold for reporting “found” missing offenders, and/or a selected geographic scope for missing offenders which may be different from the scope used for reporting current, properly registered, offenders. Other profile criteria may be stored or provided on a report by a report basis according to the design of the reporting system. The list of missing entries may be added in step S310 to the report cache along with information indicating the reliability of the “found” entry, the identifying and PIP-type information obtained may also be included.

In step S311, which may be included in the embodiment of FIG. 23A (as may any of the foregoing steps), the profile of information for each entry in the report cache may be augmented by searching public information databases, in PIP fashion, to add additional information to the offender report. Such information may include a history of domiciles, aliases used by the offenders, photographs, lifestyle information, people with whom the offenders have cohabited, business operated by the offender, and other such PIP-type information. Any or all of such information may included in the report cache. Note that although the procedure of FIG. 23A suggests that such additional data would be derived each time a report is generated, the PIP type data may be attached to missing offender information on a different schedule that is quite independent such that the expense and burden of preparing it may be mitigated.

Perhaps the most important additional information that may be added to a report about offenders is information about potential points of contact between offender and subscriber or those of concern to the subscriber. For example, information such as the offender's work address, employment or lack thereof, commuting bus route that may be used (which may be inferred from lack of a registered vehicle and location of employment relative to residence, for example), car commuter route, car description/plates, venues frequented (which may require a rule base to make inferences from data associated with the offender and nearby locations of interest such as libraries, hobby retailers, etc.), post office, house of worship, parks/sports venues, etc. Various ways of backing into this information may be made using techniques of collaborative filtering. For example, the religion and likelihood that an offender would attend a particular local house of worship may be inferred from charitable contributions, political affiliation (derived from voter registration records), and other information.

Offenders often must be registered even if they are incarcerated. It would be relevant for a report to point out, or make it possible for the subscriber (through settings in her profile) to filter out, offender entries that correspond to prison inmates. This can make a rather large difference in the report of a subscriber living near a prison, perhaps unknowingly. Such features are contemplated in the present embodiment.

In a final step S312, the report is generated and transmitted to the recipient. The routine of FIG. 23A may, of course, be performed concurrently for multiple subscribers. Note that this step may be conditional or formatted based on the results found. If a subscriber only wants to be alerted about information that has changed since the last reported was received, for example, an appropriate indicator may be provided in the subscriber's profile. Then, if the report produced no, or less than a threshold quantity of information relating to offenders, then the report would not be generated and transmitted. This may require the creation and maintenance of a baseline and/or log of changes in the manner of that of FIG. 23B and such is assumed without further explanation. On the other hand, there may be certain kinds of changes or specific events that are deemed so important, either as viewed through the lens of subscriber preferences or as established by the system per se, that special alert reports may be triggered. As discussed above with respect to PIPs, either a specially highlighted report or a report narrowly focused on the information of interest may be generated. An example might be a prison break-out, a crime report, or immediate public service message. As discussed with reference to change reports, alert-type messages may be generated and delivered to subscribers for such events depending on corresponding profile settings and the nature of the information.

Note that the process of FIG. 23A may be broken into different threads iterating on different time-bases. For example, news information and public alert announcements may be filtered on a frequent basis but PIP information for missing offenders may be generated less frequently.

Further processing may be provided to annotate or refine the report prior to step S312 (or otherwise generating a report) by performing an analysis to identify and rank potential points of contact between of a subscriber and persons of concern to subscriber with offenders. In a simple version of the system, the residence, routes, and other locations frequented by the offender and corresponding locations and routes of the subscriber or parties of concern to the subscriber may be compared. The temporal information corresponding to these locations and routes would also be correlated to them so that a likelihood that a party was at the location could be determined. Then a processing engine may compare this information to identify possible locations and times of contact. These would be added to the report in addition to the basic information about the locations of contact. In a refinement, a probability of contact may be generated as well.

Still further processing may attend the generation of the report to eliminate particular classes of information according to selections by the subscriber. For example, in a sex-offender registry, if information is available about the type of offense, the subscriber may not be interested in offenders who are, say, statutory rapists but very concerned about child molesters. The subscriber profile may store this information so that such preferences can be implemented by filtering out such information. Note that this feature may be provided in the most simple version of an offender registry reporting system, such as one which simply applies a geographic filter to registered offenders and filters out based on type of offense and subscriber profile preferences.

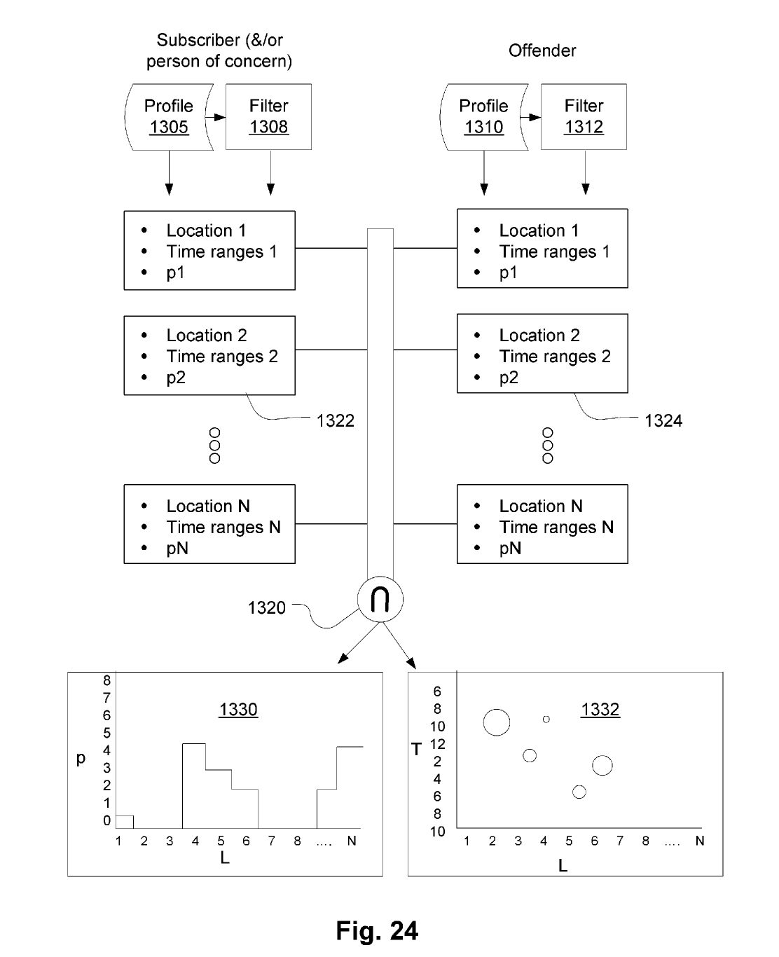

An example process is illustrated in FIG. 24 to explain the generation of points of contact further. The basic process may simply be one of identifying coincidences in the subscriber's “itinerary” (which would include all the locations the subscriber, or person of interest, might be at, or traveling through, a location so the term “itinerary” is used figuratively) with that of the offenders selected in the geographic range of the subscriber or person of concern. In FIG. 24, the operation of locating coincidences between such itineraries as the intersection operator 1320 with the itinerary data indicated at 1322, for the subscriber or person of interest and at 1324, for the subscriber. Each entry in the itineraries may have a probability associated with it or a histogram (or probability profile) representing probability vs. time. A combined probability profile by location and time may be derived from this data which may be graphically reported as, for example, a bubble chart 1330 or probability profile, by location 1332.

For obvious reasons, including subscriber convenience, there may be a relative dearth of information that is readily available to prepare such itineraries with corresponding probability information as contemplated in the embodiment of FIG. 24. However, the data that is available can be probabilistically expanded using technique of collaborative filtering or by using other techniques such as neural networks. These techniques can use diffuse or sparse information and render at least some sort of predictions about what is missing. Alternatively, stereotyped patterns may be substituted where information is lacking or incomplete. These may be stored in master profiles that may be associated with subscribers based on basic background information. The expansion of subscriber information, indicated by profile database 1305 and offender information, indicated by profile database 1310, may be done in essentially the same ways using, of course, different filters or gap-filling algorithms indicated, respectively by filters 1308 and 1312.

In terms of the discussion of FIG. 24, contact points may be defined as those locations and times when there is more than a threshold probability of a contact between a subscriber or person of concern to subscriber and an offender.

Points of contact may be characterized in terms of time of day, day of week, or other temporal frames; geographical location, range of locations; types of locations or areas (e.g., particular kinds of retail venues such as shopping malls). But they may also include information about risk factors and crime pattern profiles that correspond to them. With regard to risk factors and crime pattern profiles that correspond to contact points, consider an example in which a park, as a venue turns up as a potential contact point. Not all aspects of the park environment are of concern. For example, riding on a carousel and jogging alone on a path through heavy vegetation may correspond with very different risks. Thus it is helpful for a subscriber to know in what way a park, as a type of location, may become an actual point of contact, rather than just a predicted point of contact. So in a report, the point of contact may include such additional information about the types of contacts that are mostly like to be made the conditions that make a contact more likely.

To generate points of contact, the geographic information of subscribers, including dwelling, vacation areas, venues, and habits may be employed by the system. Examples of habits might include, for example,

For infant potential victims
(1) Do the children carry cell phones?
(2) How often do the children contact the guardians/parents?
(3) Are kids transported by guardians/parents in a car or by bus?
(4) Do guardians/parents use toddler leash or stroller in public places?
(5) What kinds of activities do the children engage in?
(6) Do kids go to after-school programs?
(7) Do they play in view of the street and which street?
(8) Does a nanny watch the children?

For adult potential victims
(1) Does the adult drink outside home and where and when?
(2) Does the adult travel alone? What routes? Where?
(3) Does the adult commute, use mass transportation, where/when?

Also, information about the nature of the locations may be used.

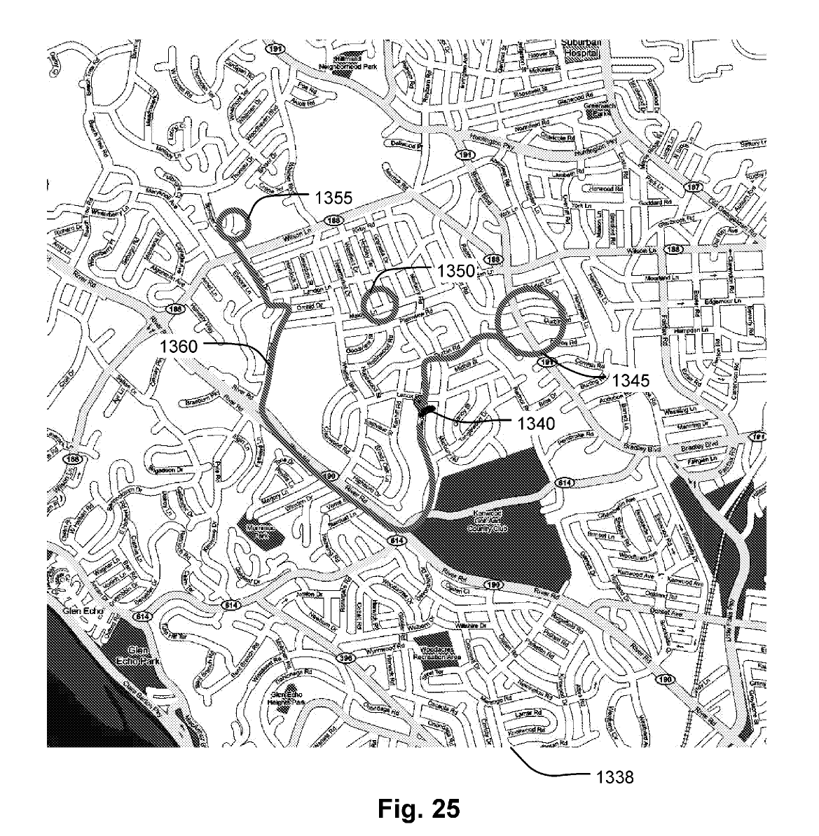

As for how reports may be provided to users, interactive maps with point of interest icons, as are well-known on the Internet can be provided. The points of interest would correspond in this case to offenders and/or possible offenders residences or the contact points in more advanced embodiments discussed above. Such a map may be augmented as illustrated in FIG. 25 to show the respective probability of a contact at the various contact points by the relative sizes of bubbles 1345, 1350 1355. Also routes 1360, 1340 may be indicated as shown. The relative weights of the lines may indicate where along travel routes the probability of contact is greatest. In addition the naked probability information, the reporting system may show how the probability was derived and the reliability associated with it. For example if the probability formula relies heavily on stereotyped information about the habits of the household, the template for those stereotypes might be shows to the user.

Although the present invention has been described herein with reference to a specific preferred embodiment, many modifications and variations therein will be readily occur to those skilled in the art. Accordingly, all such variations and modifications are included within the intended scope of the present invention as defined by the following claims.

What is claimed is:

1. A method of providing a report of public information, relating to an individual to that individual, comprising:
from at least a network server, transmitting a form with fields for obtaining identifying information, identifying said individual, to a client terminal;
receiving at at least a network server from said client terminal, identifying information associated with said form fields, said identifying information substantially uniquely identifying said individual;
at at least a network server, authenticating a requester at said client terminal to confirm that said requester is said individual;
at at least a network server, querying at least a database providing background check information to retrieve retrieved records pertaining to said identifying information and retrieving records;
generating at at least a network server, a report including data derived from said retrieved records;
said step of generating including formatting a web page to include a header showing categories of information in said web page with links to said information; and further include lists of criteria, used in said step of querying, used to retrieve the records, said lists varying depending on the category of information to which said list corresponds.

2. A method as in claim 1, wherein records are grouped by said categories in said web page and each of said lists of criteria is located adjacent a corresponding group.

3. A method as in claim 1, wherein records are grouped by said categories in said web page and wherein, adjacent each group, is an explanation or a link thereto, describing the nature of the records.

4. A method as in claim 3, wherein said explanation includes an FAQ.

5. A method as in claim 3, wherein said explanation includes an explanation of why data may be missing from the report.

6. A method as in claim 1, wherein records are grouped by said categories in said web page and adjacent each of said groups is a list of data sources from which said records were obtained.

7. A method of providing a report of public information, relating to an individual, to that individual, comprising:
from at least a network server, transmitting a form with fields for obtaining identifying information identifying said individual, to a client terminal;
receiving at least a network server from said client terminal, identifying information associated with said form fields, said identifying information substantially uniquely identifying said individual;
at least a network server, authenticating a requester at said client terminal to confirm that said requester is said individual;
at least a network server, querying at least a database providing background check information to retrieve retrieved records pertaining to said identifying information and retrieving records;
said step of querying including submitting various queries whose results may or may not be included in the report depending on the results of the querying;
selecting certain records to include in a report based on results of said step of querying; generating at least a network server, a report including data derived from said retrieved records;
said step of generating including formatting a web page to include a list of queries used to generate records selected in said step of selecting.

8. A method as in claim 7, further comprising transmitting said report to a client terminal.

9. A method as in claim 7, wherein said list of queries indicates a number of records retrieved based on each of the queries appearing in said list.

10. A method as in claim 7, wherein said background information includes address data, real estate records and name data.

11. A method as in claim 7, wherein said list of queries includes at least a portion of a social security number and at least one format of name and address of said individual.

12. A method as in claim 7, wherein said list is shown as an expanded list and can be collapsed by user-selection of a web control or link, a collapsed representation of the list including a control to permit display of the complete list and a summary of the list in the form of at least a total count or records in said list.
